(19) United States
(12) Patent Application Publication
(10) Pub. No.: US 2023/0322990 A1
(43) Pub. Date: Oct. 12, 2023

(54) Modified Conjugated Diene-Based Polymer, Production Method for Modified Conjugated Diene-Based Polymer, Modified Conjugated Diene-Based Polymer Composition, and Rubber Composition

(71) Applicant: Asahi Kasei Kabushiki Kaisha, Tokyo (JP)

(72) Inventors: Takaaki Ushio, Tokyo (JP); Yuta Hashizume, Tokyo (JP)

(73) Assignee: Asahi Kasei Kabushiki Kaisha, Tokyo (JP)

(21) Appl. No.: 18/133,175

(22) Filed: Apr. 11, 2023

(30) Foreign Application Priority Data
Apr. 11, 2022 (JP) 2022-065367

(51) Int. Cl. C08F 236/10; C08F 8/30; C08F 8/42; C08L 9/06; C08K 3/36

(52) U.S. Cl. CPC C08F 236/10; C08F 8/30; C08F 8/42; C08L 9/06; C08K 3/36

(57) ABSTRACT

The present disclosure provides a modified conjugated diene-based polymer excellent in form retainability, and excellent in abrasion resistance, fracture performance and a low hysteresis loss property of a vulcanizate obtained therefrom, and a method for producing the same, and a modified conjugated diene-based polymer composition and a rubber composition using the modified conjugated diene-based polymer, etc.

### BACKGROUND OF THE INVENTION

### Field of the Invention

The present invention relates to a modified conjugated diene-based polymer, a production method for a modified conjugated diene-based polymer, a modified conjugated diene-based polymer composition, and a rubber composition, etc.

### Description of the Related Art

In recent years, there has been an increasing demand for reduction of fuel consumption in vehicles, and improvement of rubber materials used in a vehicle tire, particularly, in a tire tread coming in contact with a road surface is required.

Besides, owing to increasing requirements for fuel economy regulations for vehicles, there are increasing requirements for using resins for vehicle members, and reducing the thickness of a tire for purposes of weight reduction of vehicles.

For reducing the thickness of a tire, it is necessary to reduce the thickness of a tread portion having a high material ratio in the entire tire and coming in contact with a road surface, and there is a demand for a rubber material more superior in abrasion resistance more than ever.

In addition, in order to reduce energy loss caused by tires during driving, a material having low rolling resistance, namely, having a low hysteresis loss property, is preferred as a rubber material used in a tread.

Furthermore, from the viewpoint of safety, a tire material is required to have practically sufficient fracture strength.

An example of a rubber material meeting the aforementioned requirements includes a rubber composition containing a rubber-like polymer and a reinforcing filler such as carbon black or silica.

In such a rubber composition, an attempt has been made to reduce a hysteresis loss and to improve abrasion resistance and fracture strength by improving dispersibility of silica in the rubber composition through introduction of a functional group having affinity or reactivity with silica into a molecular end of a rubber-like polymer having high mobility, and furthermore, by reducing the mobility of the molecular end of the rubber-like polymer.

For example, Japanese Patent Laid-Open Nos. 2005-290355, 11-189616, and 2003-171418 disclose a composition of a modified conjugated diene-based polymer obtained by reacting an alkoxysilane having an amino group with a conjugated diene-based polymer active end, and silica. Besides, International Publication No. WO 2020/013638 discloses a composition of a modified conjugated diene-based polymer and silica improved in hysteresis loss and abrasion resistance and excellent in processability.

When the present inventors examined conventional rubber compositions including those of Japanese Patent Laid-Open Nos. 2005-290355, 11-189616, and 2003-171418 and International Publication No. WO 2020/013638, however, it was found that the conventional rubber compositions are insufficient in their physical properties. For example, a decreased molecular weight of a modified conjugated diene-based polymer increases functional groups having affinity and reactivity with silica and improves the dispersion of silica. However, when such a material is vulcanized, in particular, formed into a vulcanizate containing an inorganic filler such as silica, rupture strength and abrasion resistance are not sufficient.

Besides, the decreased molecular weight of the modified conjugated diene-based polymer impairs the form retainability of the modified conjugated diene-based polymer and easily causes so-called clod flow. Although modified conjugated diene copolymers that are generally used in tire materials are handled as bales, tire productivity is reduced if the modified conjugated diene copolymers are deformed during transport after production.

Accordingly, the present invention has been made in light of the above-described problems. An object of the present invention is to provide a modified conjugated diene-based polymer excellent in form retainability, and excellent in abrasion resistance, fracture performance and a low hysteresis loss property of a vulcanizate obtained therefrom, and a method for producing the same, and a modified conjugated diene-based polymer composition and a rubber composition using the modified conjugated diene-based polymer, etc.

### SUMMARY OF THE INVENTION

The present inventors have made earnest studies to solve the above-described problems, resulting in finding that a modified conjugated diene-based polymer having a nitrogen content and a silicon content, a Mooney viscosity, a Mooney stress relaxation rate, a glass transition temperature, and a phase difference index falling in prescribed ranges is excellent in form retainability, and is excellent in abrasion resistance, fracture performance and a low hysteresis loss property of a vulcanizate obtained therefrom, and thus, the present invention has been accomplished. Specifically, the present invention is as follows:

[1]

A modified conjugated diene-based polymer, comprising a nitrogen atom and a silicon atom, wherein

a Mooney viscosity measured at 100° C. is 100 or more and 150 or less, a Mooney stress relaxation rate measured at 100° C. is 0.40 or more and 0.70 or less, a glass transition temperature Tg is −90° C. to −40° C., and a phase difference index measured at 160° C. and 0.1 Hz is 0.65 or more and 1.10 or less, and

each of a nitrogen content and a silicon content is 50 ppm or more based on a mass with respect to the total amount of the modified conjugated diene-based polymer.

[2]

The modified conjugated diene-based polymer according to [1], wherein

the modified conjugated diene-based polymer has a molecular weight distribution (Mw/Mn) of 1.5 or more and less than 2.5.

[3]

The modified conjugated diene-based polymer according to [1] or [2], wherein

the Mooney viscosity measured at 100° C. is 100 or more and 130 or less.

[4]

The modified conjugated diene-based polymer according to any one of [1] to [3], wherein

the Mooney stress relaxation rate measured at 100° C. is 0.50 or more and 0.70 or less.

[5]

The modified conjugated diene-based polymer according to any one of [1] to [4], wherein

a vinyl bond content in the conjugated diene-based polymer is 15 to 43%.

[6]

A method for producing the modified conjugated diene-based polymer according to any one of [1] to [5], comprising:

a step of obtaining a modified conjugated diene-based polymer by polymerizing at least a conjugated diene compound and an aromatic vinyl compound with an organic lithium compound used as a polymerization initiator, and with a coupling modifier reacted.

[7]

A modified conjugated diene-based polymer composition, comprising

100 parts by mass of the modified conjugated diene-based polymer according to any one of [1] to [5], and

1.0 part by mass or more and 60 parts by mass or less of a rubber softener.

[8]

A rubber composition, comprising

a rubber component comprising 50 parts by mass or more of the modified conjugated diene-based polymer according to any one of [1] to [5], and

5.0 parts by mass or more and 150 parts by mass or less of a filler with respect to 100 parts by mass of the rubber component.

The present invention can provide a modified conjugated diene-based polymer excellent in form retainability, and excellent in abrasion resistance, fracture performance and a low hysteresis loss property of a vulcanizate obtained therefrom, and a method for producing the same, and a modified conjugated diene-based polymer composition and a rubber composition using the modified conjugated diene-based polymer, etc.

### DETAILED DESCRIPTION OF THE PREFERRED EMBODIMENTS

Now, an embodiment of the present invention (hereinafter referred to as the “present embodiment”) will be described in detail. It is noted that the following embodiment is merely an example for describing the present invention and the present invention is not limited thereto. Specifically, the present invention can be practiced with various modifications made without departing from the scope thereof. It is noted that when the term “to” is used herein to express numerical values or physical property values flanking the term “to”, these flanking values are included in the range.

[Modified Conjugated Diene-Based Polymer]

A modified conjugated diene-based polymer of the present embodiment contains a nitrogen atom and a silicon atom, wherein a Mooney viscosity measured at 100° C. is 100 or more and 150 or less, a Mooney stress relaxation rate measured at 100° C. is 0.40 or more and 0.70 or less, a glass transition temperature Tg is −90° C. to −40° C., and a phase difference index measured at 160° C. and 0.1 Hz is 0.65 or more and 1.10 or less, and each of a nitrogen content and a silicon content is 50 ppm or more based on a mass with respect to the total amount of the modified conjugated diene-based polymer.

(Conjugated Diene Compound and Aromatic Vinyl Compound)

The modified conjugated diene-based polymer of the present embodiment is a copolymer of at least one conjugated diene compound and at least one aromatic vinyl compound. In the following description, a unit derived from the conjugated diene compound in the copolymer is referred to as a conjugated diene unit, and a unit derived from the aromatic vinyl compound in the copolymer is referred to as an aromatic vinyl unit.

The conjugated diene compound is not especially limited, and examples include 1,3-butadiene, isoprene, 2,3-dimethyl-1,3-butadiene, 1,3-pentadiene, 3-methyl-1,3-pentadiene, 1,3-hexadiene, and 1,3-heptadiene. Among these, 1,3-butadiene and isoprene are preferred from the viewpoint that the effects of the present embodiment are effectively and definitely exhibited. One of these conjugated diene compounds may be singly used, or two or more of these may be used together.

The aromatic vinyl compound is not especially limited, and examples include styrene, p-methylstyrene, α-methylstyrene, vinylethylbenzene, vinylxylene, vinylnaphthalene, and diphenylethylene. Among these, styrene is preferred from the viewpoint that the effects of the present embodiment are effectively and definitely exhibited. One of these aromatic vinyl compounds may be singly used, or two or more of these may be used together.

(Bound Aromatic Vinyl Content and Vinyl Bond Content in Bound Conjugated Diene)

In a microstructure of the modified conjugated diene-based polymer, the lower limit of the bound aromatic vinyl content is not especially limited and is preferably 1% by mass, more preferably 2% by mass, further preferably 3% by mass, and particularly preferably 5% by mass with respect to the entire modified conjugated diene-based polymer. The upper limit of the bound aromatic vinyl content is not especially limited and is preferably 22% by mass, more preferably 21% by mass, and further preferably 20% by mass. For example, in a preferred range of the vinyl bond content described below, a glass transition temperature described below is obtained on the order of −90° C. to −67° C. when the bound aromatic vinyl content is the lower limit, and the glass transition temperature is obtained on the order of −61° C. to −40° C. when the bound aromatic vinyl content is the upper limit. Hence, when the bound aromatic vinyl content falls in the above-described range, processability of a vulcanizate of the modified conjugated diene-based polymer tends to be further improved. The bound aromatic vinyl content may fall in a range obtained by arbitrarily combining any of the upper limits and any of the lower limits, and may be, for example, 1% by mass or more and 20% by mass or less. Herein, the term “the bound aromatic vinyl content” means a content (for example, an amount of bound styrene when the aromatic vinyl compound is styrene) of a portion derived from the aromatic vinyl compound in the entire modified conjugated diene-based polymer.

In the microstructure of the modified conjugated diene-based polymer, the amount of bound conjugated diene is not especially limited and is preferably 78% by mass or more and 99% by mass or less, more preferably 78% by mass or more and 98% by mass or less, and further preferably 79% by mass or more and 95% by mass or less in the entire modified conjugated diene-based polymer. When the amount of bound conjugated diene falls in the above-described range, a low temperature characteristic of a vulcanizate of the modified conjugated diene-based polymer tends to be further improved. The amount of bound conjugated diene may be, within the above-described range, 99% by mass or less, 98% by mass or less, 97% by mass or less, or 95% by mass or less. Besides, the amount of bound conjugated diene may be, within the above-described range, 78% by mass or more, 79% by mass or more, or 80% by mass or more. The amount of bound conjugated diene may fall in a range obtained by arbitrarily combining any of the upper limits and any of the lower limits. Herein, the term “amount of bound conjugated diene” means a content of a portion derived from the conjugated diene compound in the entire modified conjugated diene-based polymer.

In the microstructure of the modified conjugated diene-based polymer, the vinyl bond content in the bound conjugated diene (hereinafter, simply referred to also as “the vinyl bond content”) is not especially limited and is preferably 15% by mol or more and 43% by mol or less, more preferably 16% by mol or more and 40% by mol or less, and further preferably 17% by mol or more and 38% by mol or less in the entire bound conjugated diene. For example, in a preferred range of the bound aromatic vinyl content, a glass transition temperature described below is obtained on the order of −90° C. to −61° C. when the vinyl bond content is the lower limit, and the glass transition temperature described below is obtained on the order of −67° C. to −40° C. when the vinyl bond content is the upper limit. Hence, when the vinyl bond content falls in the above-described range, the modified conjugated diene-based polymer is decreased in the amount of cis bond in bound conjugated diene, inhibited from being crystallized, and hence tends to be excellent in low temperature characteristic. The vinyl bond content may fall in a range obtained by arbitrarily combining any of the upper limits and any of the lower limits, and may be, for example, 15% by mol or more and 40% by mol or less. Herein, the term “the vinyl bond content in bound conjugated diene” means a molar ratio of a portion having a vinyl bond in the portion derived from the conjugated diene compound (hereinafter referred to as the “bound conjugated diene”).

Here, the bound aromatic vinyl content can be calculated by measuring UV absorption of an aromatic group (for example, a phenyl group) contained in the unit derived from an aromatic vinyl compound (hereinafter referred to as the “bound aromatic vinyl unit”) of the modified conjugated diene-based polymer. When the modified conjugated diene-based polymer consists of a bound aromatic vinyl unit and a bound conjugated diene unit, the amount of the bound conjugated diene can be obtained based on the amount of the bound aromatic vinyl obtained as described above. Specifically, it may be measured by a method described in the examples below.

When the modified conjugated diene-based polymer is, for example, a copolymer of butadiene and styrene, the vinyl bond content (amount of 1,2-vinyl bond) in bound butadiene can be obtained by Hampton method (R. R. Hampton, Analytical Chemistry, 21, 923 (1949)). Specifically, it may be measured by a method described in the examples below.

The modified conjugated diene-based polymer of the present embodiment preferably contains a few or no blocks in which 30 or more bound aromatic vinyl units are chained. When the copolymer is, for example, a butadiene-styrene copolymer, the content of such blocks in each of which 30 or more bound aromatic vinyl units are chained can be measured by employing a known method, for example, a method in which the copolymer is decomposed by Kolthoff method (a method described by I. M. Kolthoff, et al., J. Polym. Sci. 1, 429 (1946)) to analyze the amount of polystyrene insoluble in methanol. The content of the blocks in each of which 30 or more bound aromatic vinyl units are chained measured by such a method is not especially limited and is preferably 5.0% by mass or less, and more preferably 3.0% by mass or less with respect to the total amount of the modified conjugated diene-based polymer. The lower limit thereof is not especially limited and may be 0.0% by mass or more and is more preferably 0.0% by mass with respect to the total amount of the modified conjugated diene-based polymer.

From the viewpoint of further improving low fuel consumption performance, in the modified conjugated diene-based polymer of the present embodiment, a larger proportion of the bound aromatic vinyl units is preferably present singly, i.e., a lower proportion of the aromatic vinyl units is preferably adjacent to each other. Specifically, if the copolymer is, for example, a butadiene-styrene copolymer, when the copolymer is decomposed by employing a method through ozonolysis of a method of Tanaka et al., (Polymer, 22, 1721 (1981)) to analyze a bound aromatic vinyl chain distribution (in the case of this example, a styrene chain distribution) by gel permeation chromatography (hereinafter also referred to as “GPC”), it is preferable that the amount of isolated aromatic vinyl (in the case of this example, the amount of isolated styrene), with respect to the total bound aromatic vinyl content (in the case of this example, the total amount of bound styrene), is 40% by mass or more, and that the amount of a chain aromatic vinyl structure (in the case of this example, a chain styrene structure) consisting of 8 or more chained aromatic vinyl (in the case of this example, styrene) is 5.0% by mass or less. A vulcanizate obtained from such a modified conjugated diene-based polymer tends to be more superior in a low hysteresis loss property.

The bound aromatic vinyl content, the amount of bound conjugated diene, and the vinyl bond content also affect a glass transition temperature (hereinafter also referred to as the “Tg”) of the modified conjugated diene-based polymer. The glass transition temperature can be controlled by causing the bound aromatic vinyl content, the amount of bound conjugated diene, and the vinyl bond content to fall in the above-described numerical ranges of 1% by mass or more and 22% by mass or less, 78% by mass or more and 99% by mass or less, and 15% by mol or more and 43% by mol or less, respectively. When the bound aromatic vinyl content is increased, the Tg tends to be increased. Alternatively, when the vinyl bond content is increased, the Tg tends to be increased. When the bound aromatic vinyl content is set to 1% by mass or more and the vinyl bond content is set to 15% by mol, the Tg tends to be on the order of −90° C. For example, when the bound aromatic vinyl content is set to 22% by mass or more and the vinyl bond content is set to 43% by mol, the Tg tends to be on the order of −40° C.

(Glass Transition Temperature)

The glass transition temperature (Tg) of the modified conjugated diene-based polymer of the present embodiment is not especially limited and is preferably −90° C. or more, and more preferably −80° C. or more. Besides, the glass transition temperature is preferably −40° C. or less, and more preferably −43° C. or less. When the glass transition temperature falls in the above-described range, a vulcanizate of the modified conjugated diene-based polymer tends to be further excellent in abrasion resistance and a low hysteresis loss property. The glass transition temperature may fall in a range obtained by arbitrarily combining any of the upper limits and any of the lower limits. The glass transition temperature of the modified conjugated diene-based polymer is measured in accordance with ISO 22768: 2017. More specifically, a differential scanning calorimetry (DSC) curve is recorded by measuring DSC with a temperature increased within a prescribed range, and a peak top (infection point) of a DSC differential curve thus obtained is defined as the glass transition temperature. Specifically, it may be measured by a method described in examples below.

(Average Molecular Weight)

A weight average molecular weight (Mw) measured by a GPC measurement method of the modified conjugated diene-based polymer of the present embodiment is not especially limited and is preferably 30×10⁴ or more, more preferably 40×10⁴ or more, further preferably 45×10⁴ or more, and particularly preferably 50×10⁴ or more. When the weight average molecular weight measured by the GPC measurement method falls in the above-described range, fracture performance and abrasion resistance tend to be excellent. Besides, the weight average molecular weight is not especially limited and is preferably 150×10⁴ or less, more preferably 100×10⁴ or less, further preferably 80×10⁴ or less, and particularly preferably 70×10⁴ or less. When the weight average molecular weight falls in the above-described range, dispersibility of a filler in the vulcanizate obtained therefrom is further excellent, and practically sufficient fracture performance tends to be obtained. The weight average molecular weight may fall in a range obtained by arbitrarily combining any of the upper limits and any of the lower limits. The weight average molecular weight measured by the GPC measurement method of a modified conjugated diene-based polymer and a modified conjugated diene-based polymer described below is measured specifically by a method described in the examples below.

A number average molecular weight (Mn) measured by the GPC measurement method of the modified conjugated diene-based polymer of the present embodiment is not especially limited and is preferably 15×10⁴ or more, more preferably 20×10⁴ or more, and further preferably 25×10⁴ or more. When the number average molecular weight measured by the GPC measurement method falls in the above-described range, fracture performance and abrasion resistance tend to be excellent. Besides, the number average molecular weight is not especially limited and is preferably 75×10⁴ or less, more preferably 50×10⁴ or less, further preferably 40×10⁴ or less, and particularly preferably 35×10⁴ or less. When the number average molecular weight falls in the above-described range, dispersibility of a filler in the vulcanizate obtained therefrom is further excellent, and practically sufficient fracture performance tends to be obtained. The number average molecular weight may fall in a range obtained by arbitrarily combining any of the upper limits and any of the lower limits. The number average molecular weight measured by the GPC measurement method of the modified conjugated diene-based polymer is measured specifically by a method described in the examples below.

In the modified conjugated diene-based polymer of the present embodiment, a molecular weight distribution (Mw/Mn) which is a ratio of the weight average molecular weight (Mw) measured by the GPC measurement method to the number average molecular weight (Mn) measured by the GPC measurement method is not especially limited and is preferably 1.5 or more and less than 2.5, more preferably 1.6 or more and 2.1 or less, and further preferably 1.7 or more and 2.0 or less from the viewpoint that the effects of the present embodiment are effectively and definitely exhibited.

(The Number of Branches)

The modified conjugated diene-based polymer of the present embodiment has a branch structure, and the number of branches refers to the number of branches of the modified conjugated diene-based polymer. When the number of branches is larger, form retainability of the modified conjugated diene-based polymer tends to be improved. When the number of branches is smaller, fracture performance tends to be excellent. The number of branches of the modified conjugated diene-based polymer can be adjusted by a branching agent or a coupling modifier described below.

(Mooney Viscosity)

A Mooney viscosity measured at 100° C. of the modified conjugated diene-based polymer of the present embodiment is preferably 100 or more and 150 or less, and more preferably 100 or more and 130 or less. When the weight average molecular weight of the modified conjugated diene copolymer is higher, the Mooney viscosity tends to be increased. When the weight average molecular weight is lower, the Mooney viscosity tends to be decreased. For example, when the number of branches is 6, the Mooney viscosity tends to be near the lower limit if the weight average molecular weight is 57×10⁴, and the Mooney viscosity tends to be near the upper limit if the weight average molecular weight is 65×10⁴. When the number of branches is 4, the Mooney viscosity tends to be near the lower limit if the weight average molecular weight is 65×10⁴, and the Mooney viscosity tends to be near the upper limit if the weight average molecular weight is 80×10⁴. When the Mooney viscosity falls in the above-described range, the modified conjugated diene copolymer is decreased in fluidity and is excellent in form retainability, and fracture performance and abrasion resistance of a vulcanizate obtained therefrom tend to be further improved. The Mooney viscosity of the modified conjugated diene-based polymer can be measured by a method described in the examples below.

(Mooney Stress Relaxation Rate)

A Mooney stress relaxation rate measured at 100° C. of the modified conjugated diene-based polymer of the present embodiment is not especially limited and is preferably 0.40 or more and 0.70 or less, more preferably 0.45 or more and 0.70 or less, and further preferably 0.50 or more and 0.70 or less. The Mooney stress relaxation rate is an index of a molecular weight and the number of branches of the modified conjugated diene-based polymer. When the Mooney stress relaxation rate falls in the above-described range, form retainability of the modified conjugated diene-based polymer is improved, and fracture performance and abrasion resistance of a vulcanizate tend to be further improved. The Mooney stress relaxation rate of the modified conjugated diene-based polymer can be measured by a method described in the examples below.

Besides, the Mooney stress relaxation rate is also an index indicating modified conjugated diene copolymer's ease of becoming a viscous form. When the Mooney stress relaxation rate is higher, the viscous form is easier to become. When the Mooney stress relaxation rate is lower, the viscous form is more difficult to become. Hence, the Mooney stress relaxation rate is an index of form retainability.

When the Mooney viscosity measured at 100° C. is decreased by decreasing a molecular weight, by decreasing the number of branches, or by increasing an amount of a rubber softener to be added, the Mooney stress relaxation rate measured at 100° C. generally tends to be increased.

For example, when modified conjugated diene-based polymers having an equal Mooney viscosity measured at 100° C. are compared, a modified conjugated diene-based polymer having a larger number of branches tends to have a smaller value of the Mooney stress relaxation rate.

Therefore, in this case, the Mooney stress relaxation rate can be used as an index of the number of branches.

In the modified conjugated diene-based polymer, a purpose of setting the Mooney stress relaxation rate measured at 100° C. to 0.40 or more and 0.70 or less can be achieved by controlling the number of branches of the polymer, for example, in a range in which the Mooney viscosity measured at 100° C. is 100 to 150. For example, when the Mooney viscosity is smaller, the number of branches tends to be increased. For example, when the Mooney viscosity is 100, the Mooney stress relaxation rate tends to be near the upper limit if the number of branches is 4, and the Mooney stress relaxation rate tends to be near the lower limit if the number of branches is 5. When the Mooney viscosity is higher, the number of branches tends to be decreased. For example, when the Mooney viscosity is 150, the Mooney stress relaxation rate tends to be near the upper limit if the number of branches is 3, and the Mooney stress relaxation rate tends to be near the lower limit if the number of branches is 4. The number of branches can be controlled by the number of functional groups of a modifier, the amount of a modifier to be added, the number of functional groups of a branching agent, the amount of a branching agent to be added, or the like.

(Phase Difference Index)

When a tan δ measured at 160° C., strain of 7%, and 0.1 Hz is defined as a phase difference index, the phase difference index of the modified conjugated diene-based polymer of the present embodiment is not especially limited and is preferably 0.65 or more and 1.10 or less, and more preferably 0.70 or more and 1.00 or less. The phase difference index is an index of a molecular weight, the number of branches, and a glass transition temperature of the modified conjugated diene-based polymer. When the phase difference index falls in the above-described range, form retainability of the modified conjugated diene-based polymer is improved, and a fuel economy, fracture performance and abrasion resistance of a vulcanizate tend to be further improved. The phase difference index of the modified conjugated diene-based polymer can be measured by a method described in the examples below.

Since both the Mooney stress relaxation rate measured at 100° C. and the Mooney viscosity measured at 100° C. are functions of branches, the control of the Mooney stress relaxation rate and the control of the phase difference index have something in common. However, the phase difference index depends on a glass transition temperature Tg and differs in this point from the Mooney stress relaxation rate. The present inventors have focused on the fact that a polymer designed by controlling the Mooney viscosity or the Mooney stress relaxation rate does not exhibit intended performance in terms of balance among fuel economy, abrasion and tensility if the glass transition temperature Tg is shifted. The present inventors have conceived the present invention by finding that a composition after vulcanization exhibits reduction of fuel economy by adding the phase difference index as a control factor even if the glass transition temperature Tg fluctuates in a range of −90° C. to −40° C.

The phase difference index generally tends to be increased when the Mooney viscosity is decreased, the number of branches is decreased, or the glass transition temperature Tg is increased.

In the modified conjugated diene-based polymer, the phase difference index is adjusted to 0.65 or more and 1.10 or less by controlling the weight average molecular weight Mw and the number of branches of the polymer, for example, in a range in which the glass transition temperature Tg is −90° C. to −40° C. When the glass transition temperature Tg is decreased, the phase difference index can be controlled by decreasing the Mooney viscosity or the number of branches. For example, when the glass transition temperature Tg is −75° C. and the Mooney viscosity is 100, the phase difference index tends to be near the upper limit if the number of branches is 3, and the phase difference index tends to be near the lower limit if the number of branches is 4. When the glass transition temperature Tg is −75° C. and the Mooney viscosity is 130, the phase difference index tends to be near the upper limit if the number of branches is 2, and the phase difference index tends to be near the lower limit if the number of branches is 3. When the glass transition temperature Tg is increased, the phase difference index can be controlled by increasing the Mooney viscosity or the number of branches. For example, when the glass transition temperature Tg is −60° C. and the Mooney viscosity is 100, the phase difference index tends to be near the upper limit if the number of branches is 4, and the phase difference index tends to be near the lower limit if the number of branches is 6. When the glass transition temperature Tg is −60° C. and the Mooney viscosity is 130, the phase difference index tends to be near the upper limit if the number of branches is 3, and the phase difference index tends to be near the lower limit if the number of branches is 5. The glass transition temperature Tg can be controlled by, for example, the ratios of the bound aromatic vinyl content and the vinyl bond content in the modified conjugated diene-based polymer. Besides, the number of branches can be controlled by the number of functional groups of a modifier, the amount of a modifier to be added, the number of functional groups of a branching agent, the amount of a branching agent to be added, or the like.

(Production Method)

A method for producing a modified conjugated diene-based polymer of the present embodiment needs to perform polymerization for the modified conjugated diene-based polymer by controlling various parameters so as to be satisfied. As described above, the ratio of aromatic vinyl or the ratio of vinyl bond in conjugated diene influences the glass transition temperature Tg or the phase difference index. Therefore, a polymer chain is formed by setting conditions so as to satisfy these factors. Besides, the molecular weight or the number of branches influences the Mooney viscosity measured at 100° C. or the Mooney stress relaxation rate measured at 100° C. Therefore, a length of the polymer chain is set and an appropriate number of branches is designed so as to satisfy these factors. Since the number of branches depends on introduction of a main chain branch and the number of functional groups of a coupling agent, it is preferred to appropriately combine these factors. A nitrogen content and/or a silicon content of the modified conjugated diene-based polymer can be increased by adopting a branching agent or a coupling agent having nitrogen and/or silicon. It is therefore necessary to also adjust the contents of nitrogen and silicon to appropriate values, together with the number of branches.

Now, a polymerization step, a step of forming a main chain branch, and a coupling step will be described. These steps can be designed so as to satisfy various parameters to produce the modified conjugated diene-based polymer of the present embodiment.

(Polymerization Initiator)

The polymerization initiator is not especially limited, and for example, an organic lithium compound such as an organic monolithium compound can be used.

Examples of the organic monolithium compound include, in terms of binding mode between an organic group and lithium therein, a compound having a carbon-lithium bond, a compound having a nitrogen-lithium bond, and a compound having a tin-lithium bond.

Among these, from the viewpoint that a nitrogen atom can be introduced into a conjugated diene-based polymer, the organic monolithium compound is preferably an organic lithium compound having at least one nitrogen atom in a molecule, and more preferably an alkyllithium compound having a substituted amino group, or dialkylamino lithium.

It is noted that the substituted amino group refers to an amino group having no active hydrogen, or an amino group having active hydrogen protected.

Such an alkyllithium compound containing an amino group having no active hydrogen is not especially limited, and examples include piperidinolithium, 3-dimethylaminopropyllithium, 3-diethylaminopropyllithium, 4-(methylpropylamino)butyllithium and 4-hexamethyleneiminobutyllithium.

The alkyllithium compound containing an amino group having active hydrogen protected is not especially limited, and examples include 3-bistrimethylsilylaminopropyllithium and 4-trimethylsilylmethylaminobutyllithium.

The dialkylamino lithium is not especially limited, and examples include lithium dimethylamide, lithium diethylamide, lithium dipropylamide, lithium dibutylamide, lithium di-n-hexylamide, lithium diheptylamide, lithium diisopropylamide, lithium dioctylamide, lithium-di-2-ethylhexylamide, lithium didecylamide, lithium ethylpropylamide, lithium ethylbutylamide, lithium ethylbenzylamide, lithium methylphenetylamide, lithium hexamethyleneimide, lithium pyrrolidide, lithium piperidide, lithium heptamethyleneimide, lithium morpholide, 1-lithioazacyclooctane, 6-lithio-1,3,3-trimethyl-6-azabicyclo[3.2.1] octane, and 1-lithio-1,2,3,6-tetrahydropyridine.

Such an organic monolithium compound having a substituted amino group can be reacted with a small amount of a polymerizable monomer, such as 1,3-butadiene, isoprene or styrene, to be used also as an organic monolithium compound of a soluble oligomer.

On the other hand, the polymerization initiator of the present embodiment may be a polymerization initiator that is produced by reacting a compound represented by the chemical formula (E) or (F) with an organic metal compound, and can introduce a functional group to one end of a polymer chain formed by polymerization while starting polymerization.

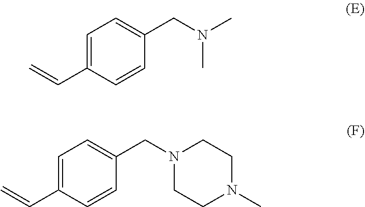

When the polymerization initiator has a nitrogen atom constituting an amino group, a chain transfer reaction easily occurs during progress of anion polymerization, and hence a reacting amount of a coupling agent or a modifier with the active end after completing the polymerization tends to be reduced. As a result, when the polymerization initiator having a nitrogen atom constituting an amino group is used, the resultant weight average molecular weight (Mw) tends to be low.

Therefore, when a nitrogen content is desired to be set high in a polymer having a comparatively high molecular weight of a weight average molecular weight (Mw) of 30×10⁴ or more, 40×10⁴ or more, or 45×10⁴ or more, it is preferable to react a nitrogen atom not on a side of a polymerization start end but on a side of a polymerization terminal end. In other words, there is a tendency that a polymer having a comparatively high molecular weight, and having nitrogen atoms at both ends is difficult to be produced. Although depending on the weight average molecular weight (Mw) and the structures of a coupling agent and a modifier, when a nitrogen atom is contained only on the side of the terminal end, a nitrogen content in the polymer is generally 0.1 ppm by mass to 1000 ppm by mass.

From the viewpoints of industrial availability and controllability of a polymerization reaction, an alkyllithium compound may be used as the organic monolithium compound. When such an organic monolithium compound is used, a conjugated diene-based polymer having an alkyl group at a polymerization start end can be obtained.

The alkyllithium compound is not especially limited, and examples include n-butyllithium, sec-butyllithium, tert-butyllithium, n-hexyllithium, benzyllithium, phenyllithium, and stilbene lithium.

As the alkyllithium compound, from the viewpoints of industrial availability and controllability of a polymerization reaction, n-butyllithium and sec-butyllithium are preferred.

One of these organic monolithium compounds may be singly used, or two or more of these may be used together. Alternatively, another organic metal compound may be used together.

Another organic metal compound is not especially limited, and examples include alkaline earth metal compounds, alkaline metal compounds excluding lithium, and other organic metal compounds.

The alkaline earth metal compounds are not especially limited, and examples include organic magnesium compounds, organic calcium compounds and organic strontium compounds. Other examples include compounds of alkoxides, sulfonates, carbonates and amides of alkaline earth metals.

Examples of the organic magnesium compounds include dibutyl magnesium and ethyl butyl magnesium.

Examples of the other organic metal compounds include organic aluminum compounds.

(Polar Compound)

The polar compound is not especially limited, and for example, ethers such as tetrahydrofuran, diethyl ether, dioxane, ethylene glycol dimethyl ether, ethylene glycol dibutyl ether, diethylene glycol dimethyl ether, diethylene glycol dibutyl ether, dimethoxybenzene, and 2,2-bis(2-oxolanyl)propane; tertiary amine compounds such as tetramethylethylenediamine, dipiperidinoethane, trimethylamine, triethylamine, pyridine, and quinuclidine; alkaline metal alkoxide compounds such as potassium-tert-amylate, potassium-tert-butylate, sodium-tert-butylate, and sodium amylate; and phosphine compounds such as triphenylphosphine can be used. One of these polar compounds may be singly used, or two or more of these may be used together.

The amount of the polar compound to be added is not especially limited, and can be adjusted in accordance with the amount of polymerization active ends, namely, the amount of the polymerization initiator to be added.

The amount of the polar compound to be added is preferably 0.010 mol or more and 1.000 mol or less, and more preferably 0.100 mol or more and 0.700 mol of less per mole of the polymerization initiator. Within the above-described range, the amount of the polar compound to be added may be 0.600 mol or less, or 0.500 mol or less per mole of the polymerization initiator.

Alternatively, the amount may be 0.150 mol or more, or 0.200 mol or more per mole of the polymerization initiator. When the amount of the polar compound to be added is equal to or smaller than the upper limit, a conjugated diene compound having a low Tg tends to be obtained. When the amount of the polar compound to be added is equal to or larger than the lower limit, there is a tendency that deactivation of a polymerization active end is suppressed to improve a coupling rate obtained in the coupling step described below. The amount of the polar compound to be added may fall in a range obtained by arbitrarily combining any of the upper limits and any of the lower limits.

(Main Chain Branch Structure)

The modified conjugated diene-based polymer of the present embodiment may have a main chain branch structure. The main chain branch structure has two or more branch points, preferably three or more branch points, and more preferably four or more branch points as branch points in the portion derived from a vinyl-based monomer containing an alkoxysilyl group or a halosilyl group.

The branch point that forms the main chain branch structure preferably has two or more polymer chains, more preferably has three or more polymer chains that are not the main chain, and further preferably has four or more polymer chains that are not the main chain.

In particular, in the main chain branch structure consisting of a vinyl-based monomer containing an alkoxysilyl group or a halosilyl group, a peak derived from the main chain branch structure is detected, in signal detection by ²⁹Si-NMR, in a range of −45 ppm to −65 ppm, and more restrictively in a range of −50 ppm to −60 ppm.

(Branching Agent)

In the modified conjugated diene-based polymer of the present embodiment, a branching agent represented by the following formula (1) or (2) is preferably used as a branching agent in constructing the main chain branch structure:

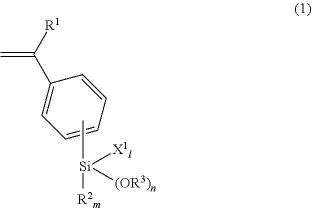

In the formula (1), R¹ represents a hydrogen atom, an alkyl group having 1 to 20 carbon atoms, or an aryl group having 6 to 20 carbon atoms, and may have a branch structure in a part thereof;

R² and R³ each independently represent an alkyl group having 1 to 20 carbon atoms, or an aryl group having 6 to 20 carbon atoms, and may have a branch structure in a part thereof;

each of R¹ to R³, if present in a plural number, is respectively independent and may be the same or different;

X¹ represents an independent halogen atom;

m represents an integer of 0 to 2, n represents an integer of 0 to 3, 1 represents an integer of 0 to 3; and

(m+n+1) represents 3.

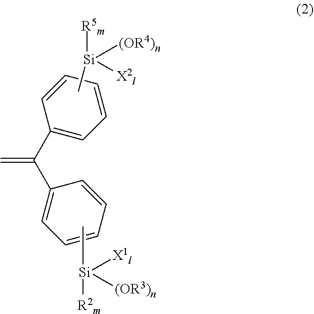

In the formula (2), R² to R⁵ each independently represent an alkyl group having 1 to 20 carbon atoms, or an aryl group having 6 to 20 carbon atoms, and may have a branch structure in a part thereof;

each of R² to R⁵, if present in a plural number, is respectively independent and may be the same or different;

X² and X³ each represent an independent halogen atom;

m represents an integer of 0 to 2, n represents an integer of 0 to 3, 1 represents an integer of 0 to 3;

(m+n+1) represents 3;

a represents an integer of 0 to 2, b represents an integer of 0 to 3, c represents an integer of 0 to 3; and

(a+b+c) represents 3.

In the present embodiment, from the viewpoints of continuity of the polymerization and improvement of the number of branches, the branching agent that is used in constructing the main chain branch structure of the modified conjugated diene-based polymer is preferably a compound represented by the formula (1) wherein R¹ is a hydrogen atom, and m=0.

In the present embodiment, from the viewpoints of improvement of the number of branches, the branching agent that is used in constructing the main chain branch structure of the modified conjugated diene-based polymer is preferably a compound represented by the formula (2) wherein m=0, and b=0.

In the present embodiment, from the viewpoints of continuity of the polymerization and improvement of the number of branches, the branching agent that is used in constructing the main chain branch structure of the modified conjugated diene-based polymer is more preferably a compound represented by the formula (1) wherein R¹ is a hydrogen atom, m=0, l=0, and n=3.

In the present embodiment, from the viewpoints of improvement of the number of branches, the branching agent that is used in constructing the main chain branch structure of the modified conjugated diene-based polymer is preferably a compound represented by the formula (2) wherein m=0, l=0, n=3, a=0, b=0, and c=3.

Examples of the branching agent represented by the formula (1) include, but are not limited to, trimethoxy(4-vinylphenyl)silane, triethoxy(4-vinylphenyl)silane, tripropoxy(4-vinylphenyl)silane, tributoxy(4-vinylphenyl)silane, triisopropoxy(4-vinylphenyl)silane, trimethoxy(3-vinylphenyl)silane, triethoxy(3-vinylphenyl)silane, tripropoxy(3-vinylphenyl)silane, tributoxy(3-vinylphenyl)silane, triisopropoxy(3-vinylphenyl)silane, trimethoxy(2-vinylphenyl)silane, triethoxy(2-vinylphenyl)silane, tripropoxy(2-vinylphenyl)silane, tributoxy(2-vinylphenyl)silane, triisopropoxy(2-vinylphenyl)silane, dimethoxymethyl(4-vinylphenyl)silane, diethoxymethyl(4-vinylphenyl)silane, dipropoxymethyl(4-vinylphenyl)silane, dibutoxymethyl(4-vinylphenyl)silane, diisopropoxymethyl(4-vinylphenyl)silane, dimethoxymethyl(3-vinylphenyl)silane, diethoxymethyl(3-vinylphenyl)silane, dipropoxymethyl(3-vinylphenyl)silane, dibutoxymethyl(3-vinylphenyl)silane, diisopropoxymethyl(3-vinylphenyl)silane, dimethoxymethyl(2-vinylphenyl)silane, diethoxymethyl(2-vinylphenyl)silane, dipropoxymethyl(2-vinylphenyl)silane, dibutoxymethyl(2-vinylphenyl)silane, diisopropoxymethyl(2-vinylphenyl)silane, dimethylmethoxy(4-vinylphenyl)silane, dimethylethoxy(4-vinylphenyl)silane, dimethylpropoxy(4-vinylphenyl)silane, dimethylbutoxy(4-vinylphenyl)silane, dimethylisopropoxy(4-vinylphenyl)silane, dimethylmethoxy(3-vinylphenyl)silane, dimethylethoxy(3-vinylphenyl)silane, dimethylpropoxy(3-vinylphenyl)silane, dimethylbutoxy(3-vinylphenyl)silane, dimethylisopropoxy(3-vinylphenyl)silane, dimethylmethoxy(2-vinylphenyl)silane, dimethylethoxy(2-vinylphenyl)silane, dimethylpropoxy(2-vinylphenyl)silane, dimethylbutoxy(2-vinylphenyl)silane, dimethylisopropoxy(2-vinylphenyl)silane, trimethoxy(4-isopropenylphenyl)silane, triethoxy(4-isopropenylphenyl)silane, tripropoxy(4-isopropenylphenyl)silane, tributoxy(4-isopropenylphenyl)silane, triisopropoxy(4-isopropenylphenyl)silane, trimethoxy(3-isopropenylphenyl)silane, triethoxy(3-isopropenylphenyl)silane, tripropoxy(3-isopropenylphenyl)silane, tributoxy(3-isopropenylphenyl)silane, triisopropoxy(3-isopropenylphenyl)silane, trimethoxy(2-isopropenylphenyl)silane, triethoxy(2-isopropenylphenyl)silane, tripropoxy(2-isopropenylphenyl)silane, tributoxy(2-isopropenylphenyl)silane, triisopropoxy(2-isopropenylphenyl)silane, dimethoxymethyl(4-isopropenylphenyl)silane, diethoxymethyl(4-isopropenylphenyl)silane, dipropoxymethyl(4-isopropenylphenyl)silane, dibutoxymethyl(4-isopropenylphenyl)silane, diisopropoxymethyl(4-isopropenylphenyl)silane, dimethoxymethyl(3-isopropenylphenyl)silane, diethoxymethyl(3-isopropenylphenyl)silane, dipropoxymethyl(3-isopropenylphenyl)silane, dibutoxymethyl(3-isopropenylphenyl)silane, diisopropoxymethyl(3-isopropenylphenyl)silane, dimethoxymethyl(2-isopropenylphenyl)silane, diethoxymethyl(2-isopropenylphenyl)silane, dipropoxymethyl(2-isopropenylphenyl)silane, dibutoxymethyl(2-isopropenylphenyl)silane, diisopropoxymethyl(2-isopropenylphenyl)silane, dimethylmethoxy(4-isopropenylphenyl)silane, dimethylethoxy(4-isopropenylphenyl)silane, dimethylpropoxy(4-isopropenylphenyl)silane, dimethylbutoxy(4-isopropenylphenyl)silane, dimethylisopropoxy(4-isopropenylphenyl)silane, dimethylmethoxy(3-isopropenylphenyl)silane, dimethylethoxy(3-isopropenylphenyl)silane, dimethylpropoxy(3-isopropenylphenyl)silane, dimethylbutoxy(3-isopropenylphenyl)silane, dimethylisopropoxy(3-isopropenylphenyl)silane, dimethylmethoxy(2-isopropenylphenyl)silane, dimethylethoxy(2-isopropenylphenyl)silane, dimethylpropoxy(2-isopropenylphenyl) silane, dimethylbutoxy (2-isopropenylphenyl)silane, dimethylisopropoxy(2-isopropenylphenyl)silane,

trichloro(4-vinylphenyl)silane, trichloro(3-vinylphenyl)silane, trichloro(2-vinylphenyl)silane, tribromo(4-vinylphenyl)silane, tribromo(3-vinylphenyl)silane, tribromo(2-vinylphenyl)silane, dichloromethyl(4-vinylphenyl)silane, dichloromethyl(3-vinylphenyl)silane, dichloromethyl(2-vinylphenyl)silane, dibromomethyl(4-vinylphenyl)silane, dibromomethyl(3-vinylphenyl)silane, dibromomethyl(2-vinylphenyl)silane, dimethylchloro(4-vinylphenyl)silane, dimethylchloro(3-vinylphenyl)silane, dimethylchloro(2-vinylphenyl)silane, dimethylbromo(4-vinylphenyl)silane, dimethylbromo(3-vinylphenyl)silane, and dimethylbromo(2-vinylphenyl)silane.

Among these, trimethoxy(4-vinylphenyl)silane, triethoxy(4-vinylphenyl)silane, tripropoxy(4-vinylphenyl)silane, tributoxy(4-vinylphenyl)silane, triisopropoxy(4-vinylphenyl)silane, trimethoxy(3-vinylphenyl)silane, triethoxy(3-vinylphenyl)silane, tripropoxy(3-vinylphenyl)silane, tributoxy(3-vinylphenyl)silane, triisopropoxy(3-vinylphenyl)silane, and trichloro(4-vinylphenyl)silane are preferred, and trimethoxy(4-vinylphenyl)silane, triethoxy(4-vinylphenyl)silane, tripropoxy(4-vinylphenyl)silane, tributoxy(4-vinylphenyl)silane, and triisopropoxy(4-vinylphenyl)silane are more preferred.

Examples of the branching agent represented by the formula (2) include, but are not limited to, 1,1-bis(4-trimethoxysilylphenyl)ethylene, 1,1-bis(4-triethoxysilylphenyl)ethylene, 1,1-bis(4-tripropoxysilylphenyl)ethylene, 1,1-bis(4-tripentoxysilylphenyl)ethylene, 1,1-bis(4-triisopropoxysilylphenyl)ethylene, 1,1-bis(3-trimethoxysilylphenyl)ethylene, 1,1-bis(3-triethoxysilylphenyl)ethylene, 1,1-bis(3-tripropoxysilylphenyl)ethylene, 1,1-bis(3-tripentoxysilylphenyl)ethylene, 1,1-bis(3-triisopropoxysilylphenyl)ethylene, 1,1-bis(2-trimethoxysilylphenyl)ethylene, 1,1-bis(2-triethoxysilylphenyl)ethylene, 1,1-bis(3-tripropoxysilylphenyl)ethylene, 1,1-bis(2-tripentoxysilylphenyl)ethylene, 1,1-bis(2-triisopropoxysilylphenyl)ethylene, 1,1-bis(4-(dimethylmethoxysilyl)phenyl)ethylene, 1,1-bis(4-(diethylmethoxysilyl)phenyl)ethylene, 1,1-bis(4-(dipropylmethoxysilyl)phenyl)ethylene, 1,1-bis(4-(dimethylethoxysilyl)phenyl)ethylene, 1,1-bis(4-(diethylethoxysilyl)phenyl)ethylene, and 1,1-bis(4-(dipropylethoxysilyl)phenyl)ethylene.

Among these, 1,1-bis(4-trimethoxysilylphenyl)ethylene, 1,1-bis(4-triethoxysilylphenyl)ethylene, 1,1-bis(4-tripropoxysilylphenyl)ethylene, 1,1-bis(4-tripentoxysilylphenyl)ethylene, and 1,1-bis(4-triisopropoxysilylphenyl)ethylene are preferred, and 1,1-bis(4-trimethoxysilylphenyl)ethylene is more preferred.

(Modifying Group Having Nitrogen Atom and Silicon Atom)

The modified conjugated diene-based polymer of the present embodiment has a modifying group. The term “modifying group” means a functional group having affinity or binding reactivity with a filler and containing a nitrogen atom. Since the modified conjugated diene-based polymer has such a modifying group, the interaction with a filler is further improved, and hence, when a modified conjugated diene-based polymer composition containing the modified conjugated diene-based polymer and the filler is obtained, mechanical strength of the composition is further improved. From a similar viewpoint, the modified conjugated diene-based polymer of the present embodiment has a silicon atom and a nitrogen atom. One modifying group or modifier does not have to contain both of a nitrogen atom and a silicon atom, and a modifying group containing one of them or a modifier having the modifying group may be set in combination such that the polymer contains predetermined amounts of both of a nitrogen atom and a silicon atom.

The modified conjugated diene-based polymer of the present embodiment can be obtained through modification by reacting the copolymer of a conjugated diene compound and an aromatic vinyl compound with a modifier. The modified conjugated diene-based polymer is obtained preferably through modification with a coupling modifier described below.

(Nitrogen Content and Silicon Content)

In the modified conjugated diene-based polymer of the present embodiment, each of contents of a nitrogen atom and a silicon atom is preferably 50 ppm or more based on a mass with respect to the total amount of the modified conjugated diene-based polymer. Each of the contents of a nitrogen atom and a silicon atom is more preferably 60 ppm or more, and further preferably 70 ppm or more. The content of a silicon atom is particularly preferably 100 ppm or more. The upper limit is not especially limited and is preferably on the order of 1000 ppm. This range is effective for attaining excellent abrasion resistance, fracture performance and low hysteresis loss property of a rubber composition comprising the modified conjugated diene-based polymer. The content of a nitrogen atom may be derived from a modifying group, and the content of a silicon atom may be derived from a modifying group and a branching agent described below. The nitrogen content and the silicon content in the modified conjugated diene-based polymer can be measured by a method described in the examples below.

(Modification Ratio)

Herein, the term “modification ratio” refers to a content, expressed in % by mass, of a modified conjugated diene-based polymer component having, in a polymer molecule, a specific functional group having affinity or binding reactivity with a filler to the total amount of a mixture of conjugated diene-based polymers when the mixture of a modified conjugated diene-based polymer and a non-modified conjugated diene-based polymer is obtained by modifying the conjugated diene-based polymer with a modifier. Accordingly, when the specific functional group contains a nitrogen atom, the term indicates a mass ratio of a modified conjugated diene-based polymer containing a nitrogen atom to the total amount of the mixture of the conjugated diene-based polymers.

Herein, the term “modified conjugated diene-based polymer” means a modified conjugated diene-based copolymer, and a mixture of a modified conjugated diene copolymer and a non-modified conjugated diene copolymer. The term “conjugated diene-based polymer” means a non-modified conjugated diene-based polymer.

For example, in a conjugated diene-based polymer containing a modified conjugated diene-based polymer having been modified by reacting a terminal end of a conjugated diene-based polymer with a nitrogen atom-containing modifier, a mass ratio of a modified conjugated diene-based polymer having a nitrogen atom-containing functional group derived from the nitrogen atom-containing modifier to the total amount of modified conjugated diene-based polymers corresponds to a modification ratio.

At least a part of the modified conjugated diene-based polymer of the present embodiment contains a nitrogen atom and a silicon atom. Such a modified conjugated diene-based polymer is also further excellent in abrasion resistance, fracture strength, and a low hysteresis loss property obtained in a vulcanizate formed therefrom.

From the viewpoint of improving processability in vulcanization, the modification ratio of the modified conjugated diene-based polymer of the present embodiment is preferably 50% by mass or more, more preferably 60% by mass or more, further preferably 70% by mass or more, particularly preferably 75% by mass or more, and most preferably 80% by mass or more with respect to the total amount of the modified conjugated diene-based polymers.

The upper limit of the modification ratio is not especially limited, and may be, for example, 100% by mass, 98% by mass, 95% by mass, or 90% by mass. In comparison among modified conjugated diene-based polymers having the same glass transition temperature, one having a higher modification ratio tends to be better in a low hysteresis loss property.

In the present embodiment, the modification ratio can be measured by chromatography capable of separating a functional group-containing modified component and a non-modified component. As a method using the chromatography, a method in which a column for gel permeation chromatography using, as a filler, a polar material adsorbing a specific functional group, such as silica, is used for performing quantitative determination using an internal standard of a non-adsorbed component for comparison (column adsorption GPC method) can be employed.

More specifically, the modification ratio is obtained by measuring an amount of adsorption onto a silica-based column based on a difference between a chromatogram measured on a sample solution containing a sample and low molecular weight internal standard polystyrene using a polystyrene-based gel column and a chromatogram measured on the sample solution using the silica-based column. More specifically, the modification ratio may be measured by a method described in the examples.

In the modified conjugated diene-based polymer of the present embodiment, the nitrogen content and/or the silicon content can be controlled by adjusting the amount of a modifier to be added, and a method for reacting the conjugated diene compound and the modifier.

For example, a method in which polymerization is performed by using, as a polymerization initiator, an organic lithium compound, described later, having at least one nitrogen atom in a molecule, a method in which a monomer having at least one nitrogen atom in a molecule is copolymerized, and a method in which a modifier having a structural formula described below is used may be combined.

(Coupling)

The modified conjugated diene-based polymer of the present embodiment is preferably a modified conjugated diene-based polymer obtained by a coupling reaction using a trifunctional or higher reactive compound (hereinafter, also referred to as “coupling modifier”) with an active end of the conjugated diene-based polymer.

In the coupling step, one active end of the conjugated diene-based polymer can be subjected to a coupling reaction using a coupling modifier having a nitrogen atom and/or a silicon atom to obtain a modified conjugated diene-based polymer. More specific procedures are described in a method for producing a modified conjugated diene-based polymer below.

(Coupling Modifier)

From the viewpoint of effectively and definitely exhibiting the effects of the present embodiment, the modified conjugated diene-based polymer of the present embodiment preferably has a nitrogen atom and a silicon atom. Among others, the modified conjugated diene-based polymer of the present embodiment more preferably has a structure derived from a compound represented by any of the formulas (A) to (D) given below. The modified conjugated diene-based polymer is further preferably obtained by modification using a compound represented by any of the formulas (A) to (D) given below as a coupling modifier. Examples of the compound represented by any one of the following formulas (A) to (D) will be described later. One of these coupling modifiers may be singly used, or two or more of these may be used together.

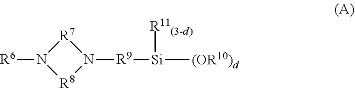

In the formula (A), R⁹ and R¹⁰ each represent a hydrocarbon group having 1 to 12 carbon atoms, may have an unsaturated bond, and may be the same or different, R¹¹ is a hydrocarbon group having 1 to 20 carbon atoms, R⁷ and R⁸ each represent an aliphatic hydrocarbon group having 1 to 6 carbon atoms, may have an unsaturated bond, and may be the same or different, R⁶ is a hydrocarbon group having 1 to 20 carbon atoms optionally substituted by an organic group containing Si, O, or N, but not having active hydrogen, and may have an unsaturated bond, and d is an integer of 1 to 3.

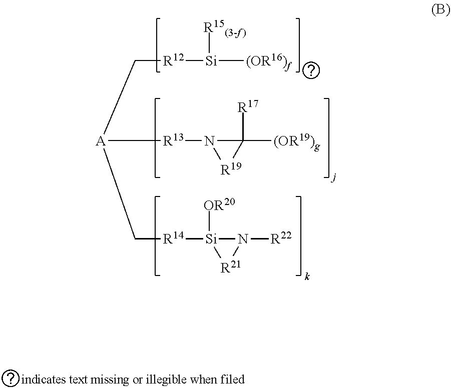

In the formula (B), A represents a hydrocarbon group having 1 to 20 carbon atoms, or an organic group having at least one atom selected from the group consisting of an oxygen atom, a nitrogen atom, a silicon atom, a sulfur atom, and a phosphorus atom, but not having active hydrogen, R¹², R¹³, and R¹⁴ each independently represent a single bond, or an alkylene group having 1 to 20 carbon atoms, R¹⁵, R¹⁶, R¹⁷, R¹⁸, and R²⁰ each independently represent an alkyl group having 1 to 20 carbon atoms, R¹⁹ and R²¹ each independently represent an alkylene group having 1 to 20 carbon atoms, R²² each independently represents an alkyl group having 1 to 20 carbon atoms, or a trialkylsilyl group, f each independently represents an integer of 1 to 3, g each independently represents 1 or 2, i represents an integer of 0 to 6, j represents an integer of 0 to 6, k represents an integer of 0 to 6, and a sum of i, j, and k is an integer of 4 to 10.

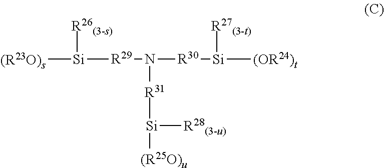

In the formula (C), R²³, R²⁴, R²⁵, R²⁶, R²⁷, and R²⁸ each independently represent an alkyl group having 1 to 20 carbon atoms, or an aryl group having 6 to 20 carbon atoms, R²⁹, R³⁰, and R³¹ each independently represent an alkylene group having 1 to 20 carbon atoms, s, t, and u each independently represent an integer of 1 to 3, and a sum of s, t, and u is an integer of 4 or more.

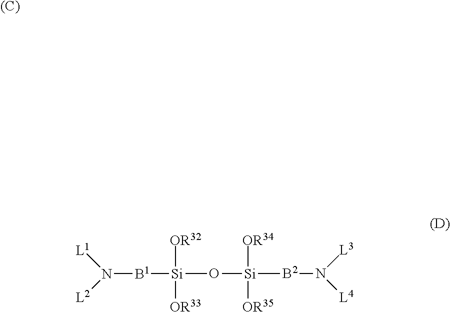

In the formula (D), B¹ and B² are each independently a bivalent hydrocarbon group having 1 to 20 carbon atoms and containing or not containing an oxygen atom, R³² to R³⁵ are each independently a monovalent hydrocarbon group having 1 to 20 carbon atoms, L¹ to L⁴ are each independently a bivalent, trivalent, or tetravalent alkylsilyl group substituted with an alkyl group having 1 to 10 carbon atoms, or a monovalent hydrocarbon group having 1 to 20 carbon atoms, L¹ and L² or L³ and L⁴ may be linked to each other to form a ring having 1 to 5 carbon atoms, and when L¹ and L² or L³ and L⁴ are linked to each other to form a ring, the formed ring may contain one to three heteroatoms of one or more types selected from the group consisting of N, O, and S.

As a specific example, in the formula (D), B¹ and B² are each independently an alkylene group having 1 to 10 carbon atoms, R³² to R³⁵ are each independently an alkyl group having 1 to 10 carbon atoms, L¹ to L⁴ are each independently a tetravalent alkylsilyl group substituted with an alkyl group having 1 to 5 carbon atoms, or an alkyl group having 1 to 10 carbon atoms, L¹ and L² or La and L⁴ may be linked to each other to form a ring having 1 to 3 carbon atoms, and when L¹ and L² or L³ and L⁴ are linked to each other to form a ring, the formed ring may contain one to three heteroatoms of one or more types selected from the group consisting of N, O, and S.

(Method for Producing Modified Conjugated Diene-Based Polymer)

The modified conjugated diene-based polymer described above can be produced by any method as long as it is a method by which a polymer having the above-described structure can be obtained. Now, preferred examples will be described in detail. When a method for producing a modified conjugated diene-based polymer of the present embodiment below is employed, the modified conjugated diene-based polymer described above can be definitely and easily obtained.

In the method for producing a modified conjugated diene-based polymer of the present embodiment, the modified conjugated diene-based polymer is obtained by a coupling step of polymerizing at least a conjugated diene compound and an aromatic vinyl compound with an organic lithium compound used as a polymerization initiator, and with a coupling modifier reacted.

The polymerization reaction of at least a conjugated diene compound and an aromatic vinyl compound is performed preferably through a growth reaction by a living anionic polymerization reaction. Thus, a conjugated diene-based polymer having an active end can be obtained. As a result, when a branching agent is added, the conjugated diene-based polymer and the branching agent efficiently react with each other.

Besides, also when the production method of the present embodiment includes a coupling step described below, a reaction with high efficiency tends to be caused.

Examples of a polymerization reaction mode include, but are not limited to, batch and continuous polymerization reaction modes.

In the continuous mode, one reactor or two or more connected reactors can be used. As a reactor for the continuous mode, for example, a tank or tubular reactor equipped with a stirrer is used. In the continuous mode, a monomer, an inert solvent described below, and a polymerization initiator described below are continuously fed to the reactor, a polymer solution containing a polymer is obtained in the reactor, and the polymer solution is continuously discharged.

As a reactor for the batch mode, for example, a tank reactor equipped with a stirrer is used. Preferably, in the batch mode, a monomer, an inert solvent described below, and a polymerization initiator described below are fed, the monomer is continuously or intermittently additionally fed if necessary, during the polymerization, a polymer solution containing a polymer is obtained in the reactor, and the polymer solution is discharged after completing the polymerization.

In the production method of the present embodiment, from the viewpoint that a conjugated diene-based polymer having an active end can be obtained at a high ratio, the polymerization reaction is caused to proceed preferably by the continuous polymerization reaction mode in which a polymer is continuously discharged to be supplied to a next reaction in a short period of time.

The amount of the polymerization initiator to be added is preferably determined based on the molecular weight of a modified conjugated diene-based polymer to be obtained. The number average molecular weight (Mn) and/or the weight average molecular weight (Mw) can be controlled in accordance with a ratio of the amount of monomers to be added to the amount of the polymerization initiator to be added. Specifically, when the ratio of the amount of the polymerization initiator to be added is reduced, the molecular weight tends to be increased, and when the ratio of the amount of the polymerization initiator to be added is increased, the molecular weight tends to be reduced.

From the viewpoint that the modified conjugated diene-based polymer of the present embodiment can be definitely and easily obtained, the polymerization reaction is preferably performed in an inert solvent.

Such an inert solvent is not especially limited, and examples include hydrocarbon solvents such as a saturated hydrocarbon and an aromatic hydrocarbon. The hydrocarbon solvent is not especially limited, and specific examples include aliphatic hydrocarbons such as butane, pentane, hexane, and heptane; alicyclic hydrocarbons such as cyclopentane, cyclohexane, methylcyclopentane, and methylcyclohexane; aromatic hydrocarbons such as benzene, toluene, and xylene; and hydrocarbons containing mixtures of any of these.

From the viewpoint that a modified conjugated diene-based polymer in which a conjugated diene compound and an aromatic vinyl compound are further randomly polymerized can be obtained, for example, the following method as described in Japanese Patent Laid-Open No. 59-140211 may be employed. Specifically, a method in which the polymerization reaction is started using the whole amount of the aromatic vinyl compound and a part of the conjugated diene compound, with the rest of the conjugated diene compound intermittently added during the polymerization reaction may be employed.

The production method of the present embodiment may include a step of removing impurities. In particular, when the monomers, the polymerization initiator and/or the inert solvent contain allenes and acetylenes as impurities, the production method of the present embodiment preferably includes, before the polymerizing branching step, the step of removing impurities. When the step of removing impurities is included, a conjugated diene-based polymer having an active end at a high concentration tends to be obtained, and a modified conjugated diene-based polymer having a high modification ratio and a large nitrogen content and/or silicon content tends to be obtained in the coupling step described below. The step of removing impurities is not especially limited, and an example includes a step of performing treatment with an organic metal compound. The organic metal compound is not especially limited, and examples include organic lithium compounds, the organic lithium compounds are not especially limited, and an example includes n-butyllithium.

(Polymerizing Branching Step)

The method for producing a modified conjugated diene-based polymer of the present embodiment may include a polymerizing branching step. This polymerizing branching step is, for example, a step of obtaining a conjugated diene-based polymer having a branch structure by polymerizing at least a conjugated diene compound and an aromatic vinyl compound with an organic lithium compound used as a polymerization initiator, and with a branching agent added. Accordingly, in the polymerizing branching step, a polymerization reaction of at least a conjugated diene compound and an aromatic vinyl compound is a principal reaction before adding a branching agent, and after adding the branching agent, a branching reaction starts.

In the polymerizing branching step, a branching reaction is started in the conjugated diene-based polymer by adding a branching agent. After adding the branching agent, a polymerization reaction for growing the conjugated diene-based polymer and a branching reaction for branching the conjugated diene-based polymer are caused in competition with each other in the reaction system. Accordingly, in accordance with the type and the amount of the branching agent to be added, and timing of adding the branching agent, the weight average molecular weight (Mw), the number average molecular weight (Mn), and the molecular weight distribution (Mw/Mn) which is a ratio therebetween in the conjugated diene-based polymer obtained in the polymerizing branching step, and the number of branches, the number of branch points, and the number of branches in each branch point of the conjugated diene-based polymer can be controlled.

The timing of adding the branching agent in the polymerizing branching step is not especially limited, and can be appropriately selected in accordance with use and the like of the modified conjugated diene-based polymer to be produced. From the viewpoints of improving the nitrogen content and/or the silicon content of the modified conjugated diene-based polymer to be obtained in the coupling step, the timing of adding the branching agent is timing, after adding the polymerization initiator, when a raw material conversion rate is preferably 20% or more, more preferably 40% or more, further preferably 50% or more, still further preferably 65% or more, and particularly preferably 75% or more. In other words, the timing of adding the branching agent is preferably timing when the polymerization reaction has been sufficiently stabilized.

The branching agent is not especially limited, and for example, a compound represented by the following formula (1) or formula (2) can be used.

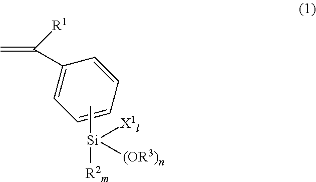

In the formula (1), R¹ represents a hydrogen atom, an alkyl group having 1 to 20 carbon atoms, or an aryl group having 6 to 20 carbon atoms, and may have a branch structure in a part thereof; R² and R³ each independently represent an alkyl group having 1 to 20 carbon atoms, or an aryl group having 6 to 20 carbon atoms, and may have a branch structure in a part thereof; each of R¹ to R³, if present in a plural number, is respectively independent and may be the same or different; X¹ each independently represents a halogen atom; and m represents an integer of 0 to 2, n represents an integer of 0 to 3, 1 represents an integer of 0 to 3, and a sum of m, n, and 1 is 3.

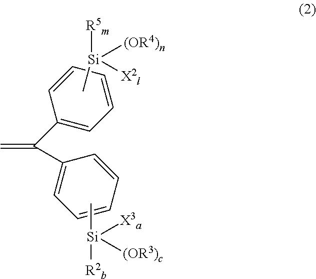

In the formula (2), R², R³, R⁴ and R⁵ each independently represent an alkyl group having 1 to 20 carbon atoms, or an aryl group having 6 to 20 carbon atoms, and may have a branch structure in a part thereof; each of R² to R⁵, if present in a plural number, is respectively independent and may be the same or different; X² and X³ each independently represent a halogen atom; m represents an integer of 0 to 2, n represents an integer of 0 to 3, 1 represents an integer of 0 to 3, and a sum of m, n, and 1 is 3; and a represents an integer of 0 to 2, b represents an integer of 0 to 3, c represents an integer of 0 to 3, and a sum of a, b, and c is 3.

Among these, from the viewpoint of suppressing inhibition of the polymerization reaction, and from the viewpoint of improving the number of branches, the branching agent is preferably a compound represented by the formula (1) wherein R¹ is a hydrogen atom, and m is 0.

Alternatively, from the viewpoint of improving the number of branches, the branching agent is preferably a compound represented by the formula (2) wherein m is 0, and b is 0.

Alternatively, from the viewpoints of continuity of the polymerization and improvement of the number of branches, the branching agent is more preferably a compound represented by the formula (1) wherein R¹ is a hydrogen atom, m is 0, 1 is 0, and n is 3.

Alternatively, from the viewpoint of improving the number of branches, the branching agent is preferably a compound represented by the formula (2) wherein m is 0, 1 is 0, n is 3, a is 0, b is 0, and c is 3.

The compound represented by the formula (1) is not limited, and examples include trimethoxy(4-vinylphenyl)silane, triethoxy(4-vinylphenyl)silane, tripropoxy(4-vinylphenyl)silane, tributoxy(4-vinylphenyl)silane, triisopropoxy(4-vinylphenyl)silane, trimethoxy(3-vinylphenyl)silane, triethoxy(3-vinylphenyl)silane, tripropoxy(3-vinylphenyl)silane, tributoxy(3-vinylphenyl)silane, triisopropoxy(3-vinylphenyl)silane, trimethoxy(2-vinylphenyl)silane, triethoxy(2-vinylphenyl)silane, tripropoxy(2-vinylphenyl)silane, tributoxy(2-vinylphenyl)silane, triisopropoxy(2-vinylphenyl)silane, dimethoxymethyl(4-vinylphenyl)silane, diethoxymethyl(4-vinylphenyl)silane, dipropoxymethyl(4-vinylphenyl)silane, dibutoxymethyl(4-vinylphenyl)silane, diisopropoxymethyl(4-vinylphenyl)silane, dimethoxymethyl(3-vinylphenyl)silane, diethoxymethyl(3-vinylphenyl)silane, dipropoxymethyl(3-vinylphenyl)silane, dibutoxymethyl(3-vinylphenyl)silane, diisopropoxymethyl(3-vinylphenyl)silane, dimethoxymethyl(2-vinylphenyl)silane, diethoxymethyl(2-vinylphenyl)silane, dipropoxymethyl(2-vinylphenyl)silane, dibutoxymethyl(2-vinylphenyl)silane, diisopropoxymethyl (2-vinylphenyl) silane, dimethylmethoxy(4-vinylphenyl)silane, dimethylethoxy(4-vinylphenyl)silane, dimethylpropoxy(4-vinylphenyl)silane, dimethylbutoxy(4-vinylphenyl)silane, dimethylisopropoxy(4-vinylphenyl)silane, dimethylmethoxy(3-vinylphenyl)silane, dimethylethoxy(3-vinylphenyl)silane, dimethylpropoxy(3-vinylphenyl)silane, dimethylbutoxy(3-vinylphenyl)silane, dimethylisopropoxy(3-vinylphenyl)silane, dimethylmethoxy(2-vinylphenyl)silane, dimethylethoxy(2-vinylphenyl)silane, dimethylpropoxy(2-vinylphenyl)silane, dimethylbutoxy(2-vinylphenyl)silane, dimethylisopropoxy(2-vinylphenyl)silane, trimethoxy(4-isopropenylphenyl)silane, triethoxy(4-isopropenylphenyl)silane, tripropoxy(4-isopropenylphenyl)silane, tributoxy(4-isopropenylphenyl)silane, triisopropoxy(4-isopropenylphenyl)silane, trimethoxy(3-isopropenylphenyl)silane, triethoxy(3-isopropenylphenyl)silane, tripropoxy(3-isopropenylphenyl)silane, tributoxy(3-isopropenylphenyl)silane, triisopropoxy(3-isopropenylphenyl)silane, trimethoxy(2-isopropenylphenyl)silane, triethoxy(2-isopropenylphenyl)silane, tripropoxy(2-isopropenylphenyl)silane, tributoxy(2-isopropenylphenyl)silane, triisopropoxy(2-isopropenylphenyl)silane, dimethoxymethyl(4-isopropenylphenyl)silane, diethoxymethyl(4-isopropenylphenyl)silane, dipropoxymethyl(4-isopropenylphenyl)silane, dibutoxymethyl(4-isopropenylphenyl)silane, diisopropoxymethyl(4-isopropenylphenyl)silane, dimethoxymethyl(3-isopropenylphenyl)silane, diethoxymethyl(3-isopropenylphenyl)silane, dipropoxymethyl(3-isopropenylphenyl)silane, dibutoxymethyl(3-isopropenylphenyl)silane, diisopropoxymethyl(3-isopropenylphenyl)silane, dimethoxymethyl(2-isopropenylphenyl)silane, diethoxymethyl(2-isopropenylphenyl)silane, dipropoxymethyl(2-isopropenylphenyl)silane, dibutoxymethyl(2-isopropenylphenyl)silane, diisopropoxymethyl(2-isopropenylphenyl)silane, dimethylmethoxy(4-isopropenylphenyl)silane, dimethylethoxy(4-isopropenylphenyl)silane, dimethylpropoxy(4-isopropenylphenyl)silane, dimethylbutoxy(4-isopropenylphenyl)silane, dimethylisopropoxy(4-isopropenylphenyl)silane, dimethylmethoxy(3-isopropenylphenyl)silane, dimethylethoxy(3-isopropenylphenyl)silane, dimethylpropoxy(3-isopropenylphenyl)silane, dimethylbutoxy(3-isopropenylphenyl)silane, dimethylisopropoxy(3-isopropenylphenyl)silane, dimethylmethoxy(2-isopropenylphenyl)silane, dimethylethoxy(2-isopropenylphenyl)silane, dimethylpropoxy(2-isopropenylphenyl)silane, dimethylbutoxy(2-isopropenylphenyl) silane, dimethylisopropoxy (2-isopropenylphenyl)silane, trichloro(4-vinylphenyl)silane, trichloro(3-vinylphenyl)silane, trichloro(2-vinylphenyl)silane, tribromo(4-vinylphenyl)silane, tribromo(3-vinylphenyl)silane, tribromo(2-vinylphenyl)silane, dichloromethyl(4-vinylphenyl)silane, dichloromethyl(3-vinylphenyl)silane, dichloromethyl(2-vinylphenyl)silane, dibromomethyl(4-vinylphenyl)silane, dibromomethyl(3-vinylphenyl)silane, dibromomethyl(2-vinylphenyl)silane, dimethylchloro(4-vinylphenyl)silane, dimethylchloro(3-vinylphenyl)silane, dimethylchloro(2-vinylphenyl)silane, dimethylbromo(4-vinylphenyl)silane, dimethylbromo(3-vinylphenyl)silane, and dimethylbromo(2-vinylphenyl)silane.

Among these, trimethoxy(4-vinylphenyl)silane, triethoxy(4-vinylphenyl)silane, tripropoxy(4-vinylphenyl)silane, tributoxy(4-vinylphenyl)silane, triisopropoxy(4-vinylphenyl)silane, trimethoxy(3-vinylphenyl)silane, triethoxy(3-vinylphenyl)silane, tripropoxy(3-vinylphenyl)silane, tributoxy(3-vinylphenyl)silane, triisopropoxy(3-vinylphenyl)silane, and trichloro(4-vinylphenyl)silane are preferred, and trimethoxy(4-vinylphenyl)silane, triethoxy(4-vinylphenyl)silane, tripropoxy(4-vinylphenyl)silane, tributoxy(4-vinylphenyl)silane, and triisopropoxy(4-vinylphenyl)silane are more preferred.

Examples of the compound represented by the formula (2) include, but are not limited to, 1,1-bis(4-trimethoxysilylphenyl)ethylene, 1,1-bis(4-triethoxysilylphenyl)ethylene, 1,1-bis(4-tripropoxysilylphenyl)ethylene, 1,1-bis(4-tripentoxysilylphenyl)ethylene, 1,1-bis(4-triisopropoxysilylphenyl)ethylene, 1,1-bis(3-trimethoxysilylphenyl)ethylene, 1,1-bis(3-triethoxysilylphenyl)ethylene, 1,1-bis(3-tripropoxysilylphenyl)ethylene, 1,1-bis(3-tripentoxysilylphenyl)ethylene, 1,1-bis(3-triisopropoxysilylphenyl)ethylene, 1,1-bis(2-trimethoxysilylphenyl)ethylene, 1,1-bis(2-triethoxysilylphenyl)ethylene, 1,1-bis(3-tripropoxysilylphenyl)ethylene, 1,1-bis(2-tripentoxysilylphenyl)ethylene, 1,1-bis(2-triisopropoxysilylphenyl)ethylene, 1,1-bis(4-(dimethylmethoxysilyl)phenyl)ethylene, 1,1-bis(4-(diethylmethoxysilyl)phenyl)ethylene, 1,1-bis(4-(dipropylmethoxysilyl)phenyl)ethylene, 1,1-bis(4-(dimethylethoxysilyl)phenyl)ethylene, 1,1-bis(4-(diethylethoxysilyl)phenyl)ethylene, and 1,1-bis(4-(dipropylethoxysilyl)phenyl)ethylene.

Among these, 1,1-bis(4-trimethoxysilylphenyl)ethylene, 1,1-bis(4-triethoxysilylphenyl)ethylene, 1,1-bis(4-tripropoxysilylphenyl)ethylene, 1,1-bis(4-tripentoxysilylphenyl)ethylene, and 1,1-bis(4-triisopropoxysilylphenyl)ethylene are preferred, and 1,1-bis(4-trimethoxysilylphenyl)ethylene is more preferred.

The amount of the branching agent to be added can be appropriately selected in accordance with use and the like of the modified conjugated diene-based polymer to be produced, and is not especially limited, and is preferably 0.020 mole or more and 0.50 mole or less, more preferably 0.030 mole or more and 0.40 mole or less, and further preferably 0.040 mole or more and 0.25 mole or less per mole of the polymerization initiator. The amount of the branching agent to be added may be, within the above-described range, 0.050 mole or more per mole of the polymerization initiator. Alternatively, the amount may be 0.20 mole or less, or 0.18 mole or less per mole of the polymerization initiator. The amount of the branching agent to be added may fall in a range obtained by arbitrarily combining any of the upper limits and any of the lower limits.

In the polymerizing branching step, the reaction temperature may be changed, or may not be changed after adding the branching agent.

In the polymerizing branching step, after adding the branching agent, a monomer of the conjugated diene-based polymer may be further additionally added, the branching agent may be additionally added thereafter, and the additional addition of the branching agent and the monomer may be further repeated.

The monomer to be added is not especially limited, and from the viewpoint of improving the nitrogen content and/or silicon content in the coupling step, the same monomer as that added as the monomer initially in the polymerizing branching step is preferably added. The amount of the monomer to be added may be 1.0% or more, 5.0% or more, 10% or more, 15% or more, or 20% or more of the total amount used as the monomer of the conjugated diene-based polymer. The amount of the monomer to be added may be 50% or less, 40% or less, or 35% or less.

When the amount of the monomer to be added falls in the above-described range, a molecular weight between a branch point generated by the addition of the branching agent and a branch point generated by the addition of the coupling modifier is increased, and hence, a molecular structure having a high linearity tends to be easily formed. When the conjugated diene-based polymer to be obtained has such a structure, entanglement among molecular chains of the conjugated diene-based polymer obtained in the form of a vulcanizate is increased, and hence, a vulcanizate excellent in abrasion resistance, steering stability and fracture strength tends to be easily obtained.

(Coupling Step)

The production method of the modified conjugated diene-based polymer of the present embodiment preferably includes a coupling step of obtaining a modified conjugated diene-based polymer by reacting the conjugated diene-based polymer having a branch structure obtained by the polymerizing branching step with a coupling modifier.

When such a coupling step is included, the conjugated diene-based polymer can be modified with a specific functional group having affinity or binding reactivity with a filler. Besides, a plurality of conjugated diene-based polymers can be coupled. Accordingly, through the production method including such a coupling step, the conjugated diene-based polymer of the present embodiment described above can be further definitely and easily obtained.

Such a coupling modifier is not especially limited as long as it is a reactive compound having a specific functional group having affinity or binding reactivity with a filler, and having 2 or more functional groups capable of reacting with an active end of the conjugated diene-based polymer. An example of the coupling modifier includes a coupling modifier containing a group having a nitrogen atom and/or a silicon atom. From the viewpoint of effectively and definitely exhibiting the effects of the present embodiment, the coupling modifier has preferably 3 or more, and more preferably 4 or more functional groups capable of reacting with an active end of the conjugated diene-based polymer. One or two or more coupling modifiers may be used.

The coupling modifier having a silicon atom-containing group is not especially limited, and examples include an alkoxysilane compound containing a nitrogen-containing group.

Examples of the nitrogen atom-containing alkoxysilane compound include, but are not especially limited to, 3-dimethylaminopropyltrimethoxysilane, 3-dimethylaminopropylmethyldimethoxysilane, 3-diethylaminopropyltriethoxysilane, 3-morpholinopropyltrimethoxysilane, 3-piperidinopropyltriethoxysilane, 3-hexamethyleneiminopropylmethyldiethoxysilane, 3-(4-methyl-1-piperazino)propyltriethoxysilane, 1-[3-(triethoxysilyl)-propyl]-3-methylhexahydropyrimidine, 3-(4-trimethylsilyl-1-piperazino)propyltriethoxysilane, 3-(3-triethylsilyl-1-imidazolidinyl)propylmethyldiethoxysilane, 3-(3-trimethylsilyl-1-hexahydropyrimidinyl)propyltrimethoxysilane, 3-dimethylamino-2-(dimethylaminomethyl)propyltrimethoxysilane, bis(3-dimethoxymethylsilylpropyl)-N-methylamine, bis(3-trimethoxysilylpropyl)-N-methylamine, bis(3-triethoxysilylpropyl)methylamine, tris(trimethoxysilyl)amine, tris(3-trimethoxysilylpropyl)amine, N,N,N′,N′-tetra(3-trimethoxysilylpropyl)ethylenediamine, 3-isocyanatopropyltrimethoxysilane, 3-cyanopropyltrimethoxysilane, 2,2-dimethoxy-1-(3-trimethoxysilylpropyl)-1-aza-2-silacyclopentane, 2,2-diethoxy-1-(3-triethoxysilylpropyl)-1-aza-2-silacyclopentane, 2-2-dimethoxy-1-(4-triemthoxysilylbutyl)-1-aza-2-silacylcohexane, 2,2-dimethoxy-1-(3-dimethoxymethylsilylpropyl)-1-aza-2-silacyclopentane, 2,2-dimethoxy-1-phenyl-1-aza-2-silacyclopentane, 2,2-diethoxy-1-butyl-1-aza-2-silacyclopentane, 2,2-dimethoxy-1-methyl-1-aza-2-silacyclopentane, 2,2-dimethoxy-8-(4-methylpiperazinyl)methyl-1,6-dioxa-2-silacyclooctane, and 2,2-dimethoxy-8-(N,N-diethylamino)methyl-1,6-dioxa-2-silacyclooctane.

A particularly preferable nitrogen atom-containing alkoxysilane compound is not especially limited, and examples include tris(3-trimethoxysilylpropyl)amine, tris(3-triethoxysilylpropyl)amine, tris(3-tripropoxysilylpropyl)amine, bis(3-trimethoxysilylpropyl)-[3-(2,2-dimethoxy-1-aza-2-silacyclopentane)propyl]amine, tetrakis(3-trimethoxysilylpropyl)-1,3-propanediamine (also designated as “N,N,N′,N′-tetrakis(3-trimethoxysilylpropyl)-1,3-propanediamine”), tris(3-trimethoxysilylpropyl)-[3-(1-methoxy-2-trimethylsilyl-1-sila-2-azacyclopentane)propyl]-1,3-propanediamine, tris(3-trimethoxysilylpropyl)-[3-(1-methoxy-2-methyl-1-sila-2-azacyclopentane)propyl]-1,3-propanediamine, bis(3-triethoxysilylpropyl)-[3-(2,2-diethoxy-1-aza-2-silacyclopentane)propyl]-[3-(1-ethoxy-2-trimethylsilyl-1-sila-2-azacyclopentane)propyl]-1,3-propanediamine, tetrakis(3-trimethoxysilylpropyl)-1,3-bisaminomethylcyclohexane, tris(3-trimethoxysilylpropyl)-[3-(2,2-dimethoxy-1-aza-2-silacyclopentane)propyl]-1,3-bisaminomethylcyclohexane, tetrakis(3-trimethoxysilylpropyl)-1,6-hexamethylenediamine, pentakis(3-trimethoxysilylpropyl)-diethylenetriamine, tris(3-trimethoxysilylpropyl)-methyl-1,3-propanediamine, tetrakis[3-(2,2-dimethoxy-1-aza-2-silacyclopentane)propyl]silane, bis(3-trimethoxysilylpropyl)-bis[3-(2,2-dimethoxy-1-aza-2-silacyclopentane)propyl]silane, tris[3-(2,2-dimethoxy-1-aza-2-silacyclopentane)propyl]-(3-trimethoxysilylpropyl)silane, tris[3-(2,2-dimethoxy-1-aza-2-silacyclopentane)propyl]-[3-(1-methoxy-2-trimethylsilyl-1-sila-2-azacyclopentane)propyl]silane, 3-tris[2-(2,2-dimethoxy-1-aza-2-silacyclopentane)ethoxy]silyl-1-trimethoxysilylpropane, 1-[3-(1-methoxy-2-trimethylsilyl-1-sila-2-azacyclopentane)propyl]-3,4,5-tris(3-trimethoxysilylpropyl)-cyclohexane, 1-[3-(2,2-dimethoxy-1-aza-2-silacyclopentane)propyl]-3,4,5-tris(3-trimethoxysilylpropyl)-cyclohexane, 3,4,5-tris(3-trimethoxysilylpropyl)-cyclohexyl-[3-(2,2-dimethoxy-1-aza-2-silacyclopentane)propyl] ether, (3-trimethoxysilylpropyl)phosphate, bis(3-trimethoxysilylpropyl)-[3-(2,2-dimethoxy-1-aza-2-silacyclopentane)propyl] phosphate, bis[3-(2,2-dimethoxy-1-aza-2-silacyclopentane)propyl]-(3-trimethoxysilylpropyl)phosphate, tris[3-(2,2-dimethoxy-1-aza-2-silacyclopentane)propyl]phosphate, N-(1,3-dimethylbutylidene)-3-(triethoxysilyl)-1-propanamine, N-(1,3-dimethylbutylidene)-3-(trimethoxysilyl)-1-propanamine, N-benzylidene-3-(triethoxysilyl)propan-1-amine, N-benzylidene-3-(trimethoxysilyl)propan-1-amine, 1,1-(1,4-phenylene)bis(N-(3-(triethoxysilyl)propyl)methanamine), 1,1-(1,4-phenylene)bis(N-(3(trimethoxysilyl)propyl)methanamine), 2-methoxy-2-methyl-1-(benzylideneaminoethyl)-1-aza-2-silacyclopentane, 2-methoxy-2-methyl-1-(4-methoxybenzylideneaminoethyl)-1-aza-2-silacyclopentane, 1-methyl-4-[3-(trimethoxysilyl)propyl]piperazine, 1-methyl-4-[3-(triethoxysilyl)propyl]piperazine, 1-methyl-4-[3-(methyldimethoxysilyl)propyl]piperazine, 3,3′-(1,1,3,3-tetramethoxydisiloxane-1,3-diyl)bis(N,N-dimethylpropan-1-amine), 3,3′-(1,1,3,3-tetraethoxydisiloxane-1,3-diyl)bis(N,N-dimethylpropan-1-amine), 3,3′-(1,1,3,3-tetrapropoxydisiloxane-1,3-diyl)bis(N,N-dimethylpropan-1-amine), 3,3′-(1,1,3,3-tetramethoxydisiloxane-1,3-diyl)bis(N,N-diethylpropan-1-amine), 3,3′-(1,1,3,3-tetramethoxydisiloxane-1,3-diyl)bis(N,N-dipropylpropan-1-amine), 3,3′-(1,1,3,3-tetraethoxydisiloxane-1,3-diyl)bis(N,N-diethylpropan-1-amine), 3,3′-(1,1,3,3-tetrapropoxydisiloxane-1,3-diyl)bis(N,N-diethylpropan-1-amine), 3,3′-(1,1,3,3-tetraethoxydisiloxane-1,3-diyl)bis(N,N-dipropylpropan-1-amine), 3,3′-(1,1,3,3-tetrapropoxydisiloxane-1,3-diyl)bis(N,N-dipropylpropan-1-amine), 3,3′-(1,1,3,3-tetramethoxydisiloxane-1,3-diyl)bis(N,N-diethylmethan-1-amine), 3,3′-(1,1,3,3-tetraethoxydisiloxane-1,3-diyl)bis(N,N-diethylmethan-1-amine), 3,3′-(1,1,3,3-tetrapropoxydisiloxane-1,3-diyl)bis(N,N-diethylmethan-1-amine), 3,3′-(1,1,3,3-tetramethoxydisiloxane-1,3-diyl)bis(N,N-dimethylmethan-1-amine), 3,3′-(1,1,3,3-tetramethoxydisiloxane-1,3-diyl)bis(N,N-dipropylmethan-1-amine), 3,3′-(1,1,3,3-tetrapropoxydisiloxane-1,3-diyl)bis(N,N-dimethylmethan-1-amine), 3,3′-(1,1,3,3-tetrapropoxydisiloxane-1,3-diyl)bis(N,N-dipropylmethan-1-amine), 3,3′-(1,1,3,3-tetraethoxydisiloxane-1,3-diyl)bis(N,N-dimethylmethan-1-amine), 3,3′-(1,1,3,3-tetraethoxydisiloxane-1,3-diyl)bis(N,N-dipropylmethan-1-amine), 1,3-bis(3-(1H-imidazol-1-yl)propyl)1,1,3,3-tetramethoxydisiloxane, 1,3-bis(3-(1H-imidazol-1-yl)propyl)1,1,3,3-tetraethoxydisiloxane, and 1,3-bis(3-(1H-imidazol-1-yl)propyl)1,1,3,3-tetrapropoxydisiloxane.

Among the coupling modifiers having a nitrogen atom-containing group, an example of the protected amine compound in which active hydrogen is substituted with a protecting group includes a compound containing, in a molecule, an alkoxysilane and a protected amine. Such a compound is not especially limited, and examples include N,N-bis(trimethylsilyl)aminopropyltrimethoxysilane, N,N-bis(trimethylsilyl)aminopropylmethyldimethoxysilane, N,N-bis(trimethylsilyl)aminopropyltriethoxysilane, N,N-bis(trimethylsilyl)aminopropylmethyldiethoxysilane, N,N-bis(trimethylsilyl)aminoethyltrimethoxysilane, N,N-bis(trimethylsilyl)aminoethylmethyldiethoxysilane, N,N-bis(triethylsilyl)aminopropylmethyldiethoxysilane, 3-(4-trimethylsilyl-1-piperazino)propyltriethoxysilane, 3-(3-triethylsilyl-1-imidazolidinyl)propylmethyldiethoxysilane, 3-(3-trimethylsilyl-1-hexahydropyrimidinyl)propyltrimethoxysilane, 2,2-dimethoxy-1-(3-trimethoxysilylpropyl)-1-aza-2-silacyclopentane, 2,2-diethoxy-1-(3-triethoxysilylpropyl)-1-aza-2-silacyclopentane, 2,2-dimethoxy-1-(4-trimethoxysilylbutyl)-1-aza-2-silacyclohexane, 2,2-dimethoxy-1-(3-dimethoxymethylsilylpropyl)-1-aza-2-silacyclopentane, 2,2-dimethoxy-1-phenyl-1-aza-2-silacyclopentane, 2,2-diethoxy-1-butyl-1-aza-2-silacyclopentane, 2,2-dimethoxy-1-methyl-1-aza-2-silacyclopentane, N-(1,3-dimethylbutylidene)-3-methyl(dimethoxysilyl)-1-propanamine, N-(1,3-dimethylbutylidene)-3-methyl(diethoxysilyl)-1-propanamine, N-(1-methylethylidene)-3-(triethoxysilyl)-1-propanamine, N-(1-methylethylidene)-3-(trimethoxysilyl)-1-propanamine, N-(1-methylethylidene)-3-methyl(dimethoxysilyl)-1-propanamine, N-(1-methylethylidene)-3-methyl(diethoxysilyl)-1-propanamine, N-ethylidene-3-(triethoxysilyl)-1-propanamine, N-ethylidene-3-(trimethoxysilyl)-1-propanamine, N-ethylidene-3-methyl(dimethoxysilyl)-1-propanamine, N-ethylidene-3-methyl(diethoxysilyl)-1-propanamine, N-(1-methylpropylidene)-3-(triethoxysilyl)-1-propanamine, N-(1-methylpropylidene)-3-(trimethoxysilyl)-1-propanamine, N-(1-methylpropylidene)-3-methyl(dimethoxysilyl)-1-propanamine, N-(1-methylpropylidene)-3-methyl(diethoxysilyl)-1-propanamine, N-benzylidene-3-methyl(dimethoxysilyl)propan-1-amine, N-benzylidene-3-methyl(diethoxysilyl)propan-1-amine, N-4-methylbenzylidene-3-(triethoxysilyl)propan-1-amine, N-4-methylbenzylidene-3-(trimethoxysilyl)propan-1-amine, N-4-methylbenzylidene-3-methyl(dimethoxysilyl)propan-1-amine, N-4-methylbenzylidene-3-methyl(diethoxysilyl)propan-1-amine, N-naphtylidene-3-(triethoxysilyl)propan-1-amine, N-naphtylidene-3-(trimethoxysilyl)propan-1-amine, N-naphtylidene-3-methyl(dimethoxysilyl)propan-1-amine, 1,1-(1,4-phenylene)bis(N-(3methyl(dimethoxysilyl)propyl)methanamine), 1,1-(1,4-phenylene)bis(N-(3methyl(diethoxysilyl)propyl)methanamine), 2-ethoxy-2-methyl-1-(benzylideneaminoethyl)-1-aza-2-silacyclopentane, and 2-methoxy-2-methyl-1-(methylisobutylideneaminoethyl)-1-aza-2-silacyclopentane, 1-trimethylsilyl-4-[3-(trimethoxysilyl)propyl]piperazine, 1-trimethylsilyl-4-[3-(triethoxysilyl)propyl]piperazine.

In the coupling step, a coupling modifier represented by any of the formulas (A) to (D) given below is preferably used. One type of these coupling modifiers can be singly used, or any combination of the formulas (A) to (D) given below may be used.

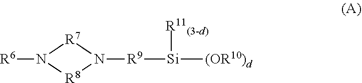

In the formula (A), R⁹ and R¹⁰ each represent a hydrocarbon group having 1 to 12 carbon atoms, may have an unsaturated bond, and may be the same or different, R¹¹ is a hydrocarbon group having 1 to 20 carbon atoms, R⁷ and R⁸ each represent an aliphatic hydrocarbon group having 1 to 6 carbon atoms, may have an unsaturated bond, and may be the same or different, R⁶ is a hydrocarbon group having 1 to 20 carbon atoms optionally substituted by an organic group containing Si, O, or N, but not having active hydrogen, and may have an unsaturated bond, and d is an integer of 1 to 3.

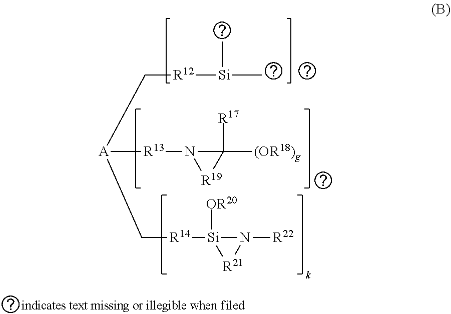

A represents a hydrocarbon group having 1 to 20 carbon atoms, or an organic group having at least one atom selected from the group consisting of an oxygen atom, a nitrogen atom, a silicon atom, a sulfur atom, and a phosphorus atom, but not having active hydrogen, R¹², R¹³ and R¹⁴ each independently represent a single bond, or an alkylene group having 1 to 20 carbon atoms, R¹⁵, R¹⁶, R¹⁷, R¹⁸, and R²⁰ each independently represent an alkyl group having 1 to 20 carbon atoms, R¹⁹ and R²¹ each independently represent an alkylene group having 1 to 20 carbon atoms, R²² each independently represents an alkyl group having 1 to 20 carbon atoms, or a trialkylsilyl group, f each independently represents an integer of 1 to 3, g each independently represents 1 or 2, i represents an integer of 0 to 6, j represents an integer of 0 to 6, k represents an integer of 0 to 6, and a sum of i, j, and k is an integer of 4 to 10.

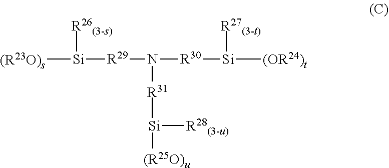

In the formula (C), R²³, R²⁴, R²⁵, R²⁶, R²⁷, and R²⁸ each independently represent an alkyl group having 1 to 20 carbon atoms, or an aryl group having 6 to 20 carbon atoms, R²⁹, R³⁰, and R³¹ each independently represent an alkylene group having 1 to 20 carbon atoms, s, t, and u each independently represent an integer of 1 to 3, and a sum of s, t, and u is an integer of 4 or more.

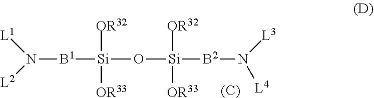

In the formula (D), B¹ and B² are each independently a bivalent hydrocarbon group having 1 to 20 carbon atoms and containing or not containing an oxygen atom, R³² to R³⁵ are each independently a monovalent hydrocarbon group having 1 to 20 carbon atoms, L¹ to L⁴ are each independently a bivalent, trivalent, or tetravalent alkylsilyl group substituted with an alkyl group having 1 to 10 carbon atoms, or a monovalent hydrocarbon group having 1 to 20 carbon atoms, L¹ and L² or L³ and L⁴ may be linked to each other to form a ring having 1 to 5 carbon atoms, and when L¹ and L² or L³ and L⁴ are linked to each other to form a ring, the formed ring may contain one to three heteroatoms of one or more types selected from the group consisting of N, O, and S.

As a specific example, in the formula (D), B¹ and B² are each independently an alkylene group having 1 to 10 carbon atoms, R³² to R³⁵ are each independently an alkyl group having 1 to 10 carbon atoms, L¹ to L⁴ are each independently a tetravalent alkylsilyl group substituted with an alkyl group having 1 to 5 carbon atoms, or an alkyl group having 1 to 10 carbon atoms, L¹ and L² or L³ and L⁴ may be linked to each other to form a ring having 1 to 3 carbon atoms, and when L¹ and L² or L³ and L⁴ are linked to each other to form a ring, the formed ring may contain one to three heteroatoms of one or more types selected from the group consisting of N, O, and S.

The coupling modifier represented by the formula (A) is not especially limited, and examples include 1-methyl-4-[3-(trimethoxysilyl)propyl]piperazine, 1-methyl-4-[3-(triethoxysilyl)propyl]piperazine, 1-propyl-4-[3-(trimethoxysilyl)propyl]piperazine, 1-propyl-4-[3-(triethoxysilyl)propyl]piperazine, 1-trimethylsilyl-4-[3-(trimethoxysilyl)propyl]piperazine, and 1-trimethylsilyl-4-[3-(triethoxysilyl)propyl]piperazine.

Among these, from the viewpoint of increasing reactivity and interaction between the conjugated diene-based polymer and the inorganic filler such as silica, and from the viewpoint of increasing processability, one represented by the formula (A) wherein d is 6 is preferred. Specifically, 1-methyl-4-[3-(trimethoxysilyl)propyl]piperazine and 1-methyl-4-[3-(triethoxysilyl)propyl]piperazine are preferred.

A reaction temperature and a reaction time in the coupling step using the coupling modifier represented by the formula (A) are not especially limited and are preferably 0° C. or more and 120° C. or less, and preferably 30 seconds or more.

The amount of the coupling modifier represented by the formula (A) to be added corresponds to a total mole number of an alkoxy group bonded to a silyl group of the coupling modifier represented by the formula (A) of preferably 0.2 times or more and 2.0 times or less, more preferably 0.5 times or more and 1 time or less, and further preferably 0.6 times or more and 0.8 times or less of a mole number of the polymerization initiator to be added. From the viewpoint that the thus obtained modified conjugated diene-based polymer has a nitrogen content and/or a silicon content, a molecular weight, and a branch structure respectively falling in more preferable ranges, the amount is preferably 0.2 times or more. Besides, from the viewpoint of suppressing deterioration of processability due to an excessively high number of branches, the amount is preferably 2.0 times or less.

More specifically, the amounts of the polymerization initiator and the coupling modifier represented by the formula (A) to be added may be adjusted so that the mole number of the polymerization initiator can be preferably 0.25 times or more, and more preferably 0.3 times or more of the mole number of the coupling modifier represented by the formula (A).

In the coupling modifier represented by the formula (B), A in the formula (B) is preferably a structure represented by any of the following formulas (I) to (III):

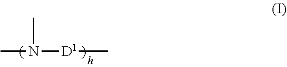

In the formula (I), D¹ represents a single bond or a bivalent hydrocarbon group having 1 to 20 carbon atoms, and h represents an integer of 1 to 10. D¹, if present in a plural number, is respectively independent and may be the same or different.

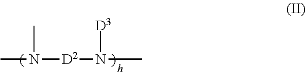

In the formula (II), D² represents a single bond or a bivalent hydrocarbon group having 1 to 20 carbon atoms, D³ represents an alkyl group having 1 to 20 carbon atoms, and h represents an integer of 1 to 10. Each of D² and D³, if present in a plural number, is respectively independent and may be the same or different.

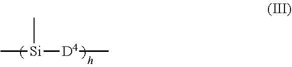

In the formula (III), D⁴ represents a single bond or a bivalent hydrocarbon group having 1 to 20 carbon atoms, and h represents an integer of 1 to 10. D⁴, if present in a plural number, is respectively independent and may be the same or different.

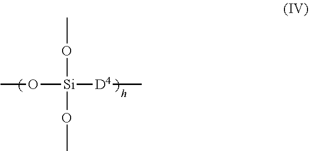

In the formula (IV), D⁵ represents a single bond or a bivalent hydrocarbon group having 1 to 20 carbon atoms, and h represents an integer of 1 to 10. D⁵, if present in a plural number, is respectively independent and may be the same or different.

In a coupling modifier represented by the formula (B), a coupling modifier in which A in the formula (B) is represented by the formula (I) is not especially limited, and examples include tris(3-trimethoxysilylpropyl)amine, bis(3-trimethoxysilylpropyl)-[3-(2,2-dimethoxy-1-aza-2-silacyclopentane)propyl]amine, bis[3-(2,2-dimethoxy-1-aza-2-silacyclopentane)propyl]-(3-trimethoxysilylpropyl)amine, tris[3-(2,2-dimethoxy-1-aza-2-silacyclopentane)propyl]amine, tris(3-ethoxysilylpropyl)amine, bis(3-triethoxysilylpropyl)-[3-(2,2-diethoxy-1-aza-2-silacylopentane)propyl]amine, bis[3-(2,2-diethoxy-1-aza-2-silacyclopentane)propyl]-(3-triethoxysilylpropyl)amine, tris[3-(2,2-diethoxy-1-aza-2-silacyclopentane)propyl]amine, tetrakis(3-trimethoxysilylpropyl)-1,3-propanediamine, tris(3-trimethoxysilylpropyl)-[3-(2,2-dimethoxy-1-aza-2-silacyclopentane)propyl]-1,3-propanediamine, bis(3-trimethoxysilylpropyl)-bis[3-(2,2-dimethoxy-1-aza-2-silacyclopentane)propyl]-1,3-propanedimane, tris[3-(2,2-dimethoxy-1-aza-2-silacyclopentane)propyl]-(3-trimethoxysilylpropyl)1,3-propanediamine, tetrakis[3-(2,2-dimethoxy-1-aza-2-silacyclopentane)propyl]-1,3-propanediamine, tris(3-trimethoxysilylpropyl)-[3-(1-methoxy-2-trimethylsilyl-1-sila-azacyclopentane)propyl]-1,3-propanediamine, bis(3-trimethoxysilylpropyl)-[3-(2,2-dimethoxy-1-aza-2-silacyclopentane)propyl]-[3-(1-methoxy-2-trimethylsilyl-1-sila-2-azacyclopentane)propyl]-1,3-propanediamine, bis[3-(2,2-dimethoxy-1-aza-2-silacyclopentane)propyl]-(3-trimethoxysilylpropyl)-[3-(1-methoxy-2-trimethylsilyl-1-sila-2-azacyclopentane)propyl]-1,3-propanediamine, tris[3-(2,2-dimethoxy-1-aza-2-silacyclopentane)propyl]-[3-(1-methoxy-2-trimethylsilyl-1-sila-2-azacyclopentane)propyl]-1,3-propanediamine, tetrakis(3-triethoxysilylpropyl)-1,3-propanediamine, tris(3-triethoxysilylpropyl)-[3-(2,2-diethoxy-1-aza-2-silacyclopentane)propyl]-1,3-propanediamine, bis(3-triethoxysilylpropyl)-bis[3-(2,2-diethoxy-1-aza-2-silacyclopentane)propyl]-1,3-propanediamine, tris[3-(2,2-diethoxy-1-aza-2-silacyclopentane)propyl]-(3-triethoxysilylpropyl)-1,3-propanediamine, tetrakis[3-(2,2-diethoxy-1-aza-2-silacyclopentane)propyl]-1,3-propanediamine, tris(3-triethoxysilylpropyl)-[3-(1-ethoxy-2-trimethylsilyl-1-sila-2-azacyclopentane)propyl]-1,3-propanediamine, bis(3-triethoxysilylpropyl)-[3-(2,2-diethoxy-1-aza-2-silacyclopentane)propyl]-[3-(1-ethoxy-2-trimethylsilyl-1-sila-2-azacyclopentane)propyl]-1,3-propanediamine, bis[3-(2,2-diethoxy-1-aza-2-silacyclopentane)propyl]-(3-triethoxysilylpropyl)-[3-(1-ethoxy-2-trimethylsilyl-1-sila-2-azacyclopentane)propyl]-1,3-propanediamine, tris[3-(2,2-diethoxy-1-aza-2-silacyclopentane)propyl]-[3-(1-ethoxy-2-trimethylsilyl-1-sila-2-azacyclopentane)propyl]-1,3-propanediamine, tetrakis(3-trimethoxysilylpropyl)-1,3-bisaminomethylcyclohexane, tris(3-trimethoxysilylpropyl)-[3-(2,2-dimethoxy-1-aza-2-silacyclopentane)proypl]-1,3-bisaminomethycyclohexane, bis(3-trimethoxysilylpropyl)-bis[3-(2,2-dimethoxy-1-aza-2-silacyclopentane)propyl]-1,3-bisaminomethylcyclohexane, tris[3-(2,2-dimethoxy-1-aza-2-silacyclopentane)propyl]-(3-trimethoxysilylpropyl)-1,3-bisaminomethylcyclohexane, tetrakis[3-(2,2-dimethoxy-1-aza-2-silacyclopentane)propyl]-1,3-propanediamine, tris(3-trimethoxysilylpropyl)-[3-(1-methoxy-2-trimethylsilyl-1-sila-2-azacyclopentane)propyl]-1,3-bisaminomethylcyclohexane, bis(3-trimethoxysilylpropyl)-[3-(2,2-dimethoxy-1-aza-2-silacyclopentane)propyl]-[3-(1-methoxy-2-trimethylsilyl-1-sila-2-azacyclopentane)propyl]-1,3-bisaminomethylcyclohexane, bis[3-(2,2-dimethoxy-1-aza-2-silacyclopentane)propyl]-(3-trimethoxysilylpropyl)-[3-(1-methoxy-2-trimethylsilyl-1-sila-2-azacyclopentane)propyl]-1,3-biasminomethylcyclohexane, tris[3-(2,2-dimethoxy-1-aza-2-cyclopentane)propyl]-[3-(1-methoxy-2-trimethylsilyl-1-sila-2-azacyclopentane)propyl]-1,3-bisaminomethylcyclohexane, tetrakis(3-triethoxysilylpropyl)-1,3-propanediamine, tris(3-triethoxysilylpropyl)-[3-(2,2-diethoxy-1-aza-2-silacyclopentane)propyl]-1,3-bisaminomethylcyclohexane, bis(3-trimethoxysilylpropyl)-bis[3-(2,2-diethoxy-1-aza-2-silacyclopentane)propyl]-1,3-bisaminomethylcyclohexane, tris[3-(2,2-diethoxy-1-aza-2-silacyclopentane)propyl]-(3-triethoxysilylpropyl)-1,3-propanediamine, tetrakis[3-(2,2-diethoxy-1-aza-2-silacyclopentane)propyl]-1,3-propanediamine, tris(3-triethoxysilylpropyl)-[3-(1-ethoxy-2-trimethylsilyl-1-sila-2-azacyclopentane)propyl]-1,3-bisaminomethylcyclohexane, bis(3-triethoxysilylpropyl)-[3-(2,2-diethoxy-1-aza-2-silacyclopentane)propyl]-[3-(1-ethoxy-2-trimethylsilyl-1-sila-2-azacyclopentane)propyl]-1,3-bisaminomethylcyclohexane, bis[3-(2,2-diethoxy-1-aza-2-silacyclopentane)propyl]-(3-triethoxysilylpropyl)-[3-(1-ethoxy-2-trimethylsilyl-1-sila-2-azacyclopentane)propyl]-1,3-bisaminomethylcyclohexane, tris[3-(2,2-diethoxy-1-aza-2-silacyclopentane)propyl]-[3-(1-ethoxy-2-trimethylsilyl-1-sila-2-azacyclopentane)propyl]-1,3-bisaminomethylcyclohexane, tetrakis(3-trimethoxysilylpropyl)-1,6-hexamethylenediamine and pentakis(3-trimethoxysilylpropyl)-diethylenetriamine.

In a coupling modifier represented by the formula (B), a coupling modifier in which A in the formula (B) is represented by the formula (II) is not especially limited, and examples include tris(3-trimethoxysilylpropyl)-methyl-1,3-propanediamine, bis(2-trimethoxysilylpropyl)-[3-(2,2-dimethoxy-1-aza-2-silacyclopentane)propyl]-methyl-1,3-propanediamine, bis[3-(2,2-dimethoxy-1-aza-2-silacyclopentane)propyl]-(3-trimethoxysilylpropyl)-methyl-1,3-propanediamine, tris(3-triethoxysilylpropyl)-methyl-1,3-propanediamine, bis(2-triethoxysilylpropyl)-[3-(2,2-diethoxy-1-aza-2-silacyclopentane)propyl]-methyl-1,3-propanediamine, bis[3-(2,2-diethoxy-1-aza-2-silacyclopentane)propyl]-(3-triethoxysilylpropyl)-methyl-1,3-propanediamine, N¹,N¹′-(propane-1,3-diyl)bis(N¹-methyl-N³,N³-bis(3-(trimethoxysilyl)propyl)-1,3-propanediamine) and N¹-(3-(bis(3-(trimethoxysilyl) propyl)amino) propyl)-N¹-methyl-N³-(3-(methyl (3-(trimethoxysilyl) propyl)amino) propyl)-N³-(3-(trimethoxysilyl)propyl)-1,3-propanediamine.

In a coupling modifier represented by the formula (B), a coupling modifier in which A in the formula (B) is represented by the formula (III) is not especially limited, and examples include tetrakis[3-(2,2-dimethoxy-1-aza-2-silacyclopentane)propyl]silane, tris[3-(2,2-dimethoxy-1-aza-2-silacyclopentane)propyl]-(3-trimethoxysilylpropyl)silane, tris[3-(2,2-dimethoxy-1-aza-2-silacyclopentane)propyl]-[3-(1-methoxy-2-trimethylsilyl-1-sila-2-azacyclopentane)propyl]silane, bis(3-trimethoxysilylpropyl)-bis[3-(2,2-dimethoxy-1-aza-2-silacyclopentane)propyl]silane, (3-trimethoxysilyl)-[3-(1-methoxy-2-trimethylsilyl-1-sila-2-azacyclopentane)-bis[3-(2,2-dimethoxy-1-aza-2-silacyclopentane)propyl]silane, bis[3-(1-methoxy-2-trimethylsilyl-1-sila-2-azacyclopentane)-bis[3-(2,2-dimethoxy-1-aza-2-silacyclopentane)propyl]silane, tris(3-trimethoxysilylpropyl)-[3-(2,2-dimethoxy-1-aza-2-silacyclopentane)propyl]silane, bis(3-trimethoxysilylpropyl)-[3-(1-methoxy-2-trimethylsilyl-1-sila-2-azacyclopentane)propyl]-[3-(2,2-dimethoxy-1-aza-2-silacyclopentane)propyl]silane, bis[3-(1-methoxy-2-trimethylsilyl-1-sila-2-azacyclopentane)propyl]-bis(3-trimethoxysilylpropyl)silane, and bis(3-trimethoxysilylpropyl)-bis[3-(1-methoxy-2-methyl-1-sila-2-azacyclopentane)propyl]silane.

Examples of the coupling modifier represented by formula (B) wherein A in the formula (B) is represented by formula (IV) include, but are not especially limited to, 3-tris[2-(2,2-dimethoxy-1-aza-2-silacyclopentane)ethoxy]silyl-1-(2,2-dimethoxy-1-aza-2-silacyclopentane)propane, and 3-tris[2-(2,2-dimethoxy-1-aza-2-silacyclopentane)ethoxy]silyl-1-trimethoxysilylpropane.

In the coupling modifier represented by the formula (B), it is more preferable that A in the formula (B) is a structure represented by the formula (I) or the formula (II), and that k is 0. A modified conjugated diene-based polymer obtained by using such a coupling modifier tends to be further excellent in abrasion resistance and a low hysteresis loss property obtained when in the form of a vulcanizate. Such a coupling modifier is not especially limited, and examples include bis(3-trimethoxysilylpropyl)-[3-(2,2-dimethoxy-1-aza-2-silacyclopentane)propyl]amine, tris(3-trimethoxysilylpropyl)amine, tris(3-triethoxysilylpropyl)amine, tris(3-trimethoxysilylpropyl)-[3-(2,2-dimethoxy-1-aza-2-silacyclopentane)propyl]-1,3-propanediamine, tetrakis[3-(2,2-dimethoxy-1-aza-2-silacyclopentane)propyl]-1,3-propanediamine, tetrakis(3-trimethoxysilylpropyl)-1,3-propanediamine, tetrakis(3-trimethoxysilylpropyl)-1,3-bisaminomethylcyclohexane, tris(3-trimethoxysilylpropyl)-methyl-1,3-propanediamine, and bis[3-(2,2-dimethoxy-1-aza-2-silacyclopentane)propyl]-(3-trismethoxysilylpropyl)-methyl-1,3-propanediamine.

In the coupling modifier represented by the formula (B), A in the formula (B) is further preferably a structure represented by the formula (I) or the formula (II), k is more preferably 0, and h is more preferably an integer of 2 to 10 in the formula (I) or the formula (II). A modified conjugated diene-based polymer obtained by using such a coupling modifier tends to be further excellent in abrasion resistance and a low hysteresis loss property obtained when in the form of a vulcanizate. Examples of such a coupling modifier include, but are not especially limited to, tetrakis[3-(2,2-dimethoxy-1-aza-2-silacyclopentane)propyl]-1,3-propanediamine, tetrakis(3-trimethoxysilylpropyl)-1,3-propanediamine, tetrakis(3-trimethoxysilylpropyl)-1,3-bisaminomethylcyclohexane, and N¹-(3-(bis(3-(trimethoxysilyl) propyl)amino) propyl)-N¹-methyl-N³-(3-(methyl(3-(trimethoxysilyl)propyl)amino)propyl)-N³-(3-(trimethoxysilyl)propyl)-1,3-propanediamine.

The amount of the coupling modifier represented by the formula (B) to be added is preferably determined based on a ratio between the mole number of the polymerization initiator to be added and the mole number of the coupling modifier represented by the formula (B) to be added. Thus, the conjugated diene-based polymer and the modifier can be adjusted to react with each other in a desired stoichiometric ratio.

More specifically, the amounts of the polymerization initiator and the amount of the coupling modifier represented by the formula (B) to be added may be adjusted so that the mole number of the coupling modifier represented by the formula (B) can be preferably 0.1 times or more and 2.0 times or less, and more preferably 0.15 times or more and 1.0 time or less of the mole number of the polymerization initiator. In this case, the number of functional groups of the coupling modifier represented by the formula (B) (for example, when i and j are 2 or more, each of w and x is present in a plural number, and plural fs and gs are respectively equal, f×i+(g+1)×j+k) is preferably an integer of 5 to 10, and more preferably an integer of 6 to 10. From the viewpoint that the thus obtained modified conjugated diene-based polymer has a nitrogen content and/or a silicon content, a molecular weight, and a branch structure respectively falling in more preferable ranges, the amounts are preferably 0.2 times or more. Besides, from the viewpoint of suppressing deterioration of fracture performance due to an excessively high number of branches, the amounts are preferably 0.5 times or less.

The coupling modifier represented by the formula (C) is not especially limited, and examples include tris(3-trimethoxysilylpropyl)amine, tris(3-methyldimethoxysilylpropyl)amine, tris(3-triethoxysilylpropyl)amine, tris(3-methyldiethoxysilylpropyl)amine, tris(trimethoxysilylmethyl)amine, tris(2-trimethoxysilylethyl)amine, and tris(4-trimethoxysilylbutyl)amine.

Among these, from the viewpoint of increasing reactivity and interaction between the modified conjugated diene-based polymer and the inorganic filler such as silica, and from the viewpoint of increasing processability, one represented by the formula (C) wherein all of n, m, and 1 are 3 is preferred. Specific examples include tris(3-trimethoxysilylpropyl)amine, and tris(3-triethoxysilylpropyl)amine.

A reaction temperature and a reaction time in the coupling step using the coupling modifier represented by the formula (C) are not especially limited and are preferably 0° C. or more and 120° C. or less, and preferably 30 seconds or more.

The amount of the coupling modifier represented by the formula (C) to be added corresponds to a total mole number of an alkoxy group bonded to a silyl group of the coupling modifier represented by the formula (C) of preferably 0.1 times or more and 2.0 times or less, more preferably 0.2 times or more and 1.0 time or less, and further preferably 0.3 times or more and 0.5 times or less of a mole number of the polymerization initiator to be added. From the viewpoint that the thus obtained modified conjugated diene-based polymer has a nitrogen content and/or a silicon content, a molecular weight, and a branch structure respectively falling in more preferable ranges, the amount is preferably 0.1 times or more. Besides, from the viewpoint of suppressing deterioration of fracture performance due to an excessively high number of branches, the amount is preferably 2.0 times or less.

The coupling modifier represented by the formula (D) is not especially limited, and examples include 3,3′-(1,1,3,3-tetramethoxydisiloxane-1,3-diyl)bis(N,N-dimethylpropan-1-amine), 3,3′-(1,1,3,3-tetraethoxydisiloxane-1,3-diyl)bis(N,N-dimethylpropan-1-amine), 3,3′-(1,1,3,3-tetrapropoxydisiloxane-1,3-diyl)bis(N,N-dimethylpropan-1-amine), 3,3′-(1,1,3,3-tetramethoxydisiloxane-1,3-diyl)bis(N,N-diethylpropan-1-amine), 3,3′-(1,1,3,3-tetramethoxydisiloxane-1,3-diyl)bis(N,N-dipropylpropan-1-amine), and 3,3′-(1,1,3,3-tetraethoxydisiloxane-1,3-diyl)bis(N,N-diethylpropan-1-amine).

A reaction temperature and a reaction time in the coupling step using the coupling modifier represented by the formula (D) are not especially limited and are preferably 0° C. or more and 120° C. or less, and preferably 30 seconds or more.

The amount of the coupling modifier represented by the formula (D) to be added corresponds to a total mole number of an alkoxy group bonded to a silyl group of the coupling modifier represented by the formula (D) of preferably 0.25 times or more and 2.0 times or less, more preferably 0.3 times or more and 1 time or less, and further preferably 0.35 times or more and 0.5 times or less of a mole number of the polymerization initiator to be added. From the viewpoint that the thus obtained modified conjugated diene-based polymer has a nitrogen content and/or a silicon content, a molecular weight, and a branch structure respectively falling in more preferable ranges, the amount is preferably 0.25 times or more. Besides, from the viewpoint of suppressing deterioration of processability due to an excessively high branch number, the amount is preferably 2.0 times or less.

The production method of the present embodiment may further include, after the coupling step, and/or before the coupling step, a condensation reaction step of causing a condensation reaction by adding a condensation accelerator.

In the production method of the present embodiment, after the coupling step, a deactivator, and/or a neutralizer may further be added if necessary to the resultant polymer solution.

The deactivator is not especially limited, and examples include water, and alcohols such as methanol, ethanol and isopropanol.

The neutralizer is not especially limited, and examples include carboxylic acids such as stearic acid, oleic acid and versatic acid (a mixture of highly branched carboxylic acids having 9 to 11 carbon atoms, and containing a principal component having 10 carbon atoms), an aqueous solution of an inorganic acid, and a carbon dioxide gas.

The production method of the present embodiment may further include a step of obtaining the resultant modified conjugated diene-based polymer from the polymer solution. As a method for this, any of known methods can be employed, and for example, the following methods may be employed. Examples of the method include a method in which the polymer is filtered after separating the solvent by steam stripping or the like, and the resultant is further dehydrated and dried to obtain the polymer, a method in which the solution is concentrated in a flushing tank, and the resultant is further devolatilized by using a bent extruder or the like to obtain the polymer, and a method in which the solution is directly devolatilized by using a drum dryer or the like to obtain the polymer.

(Modified Conjugated Diene-Based Polymer Composition)

A conjugated diene-based polymer composition of the present embodiment contains 100 parts by mass of a modified conjugated diene-based polymer, and 1.0 part by mass or more and 60 parts by mass or less of a rubber softener. When a rubber softener is added to the modified conjugated diene-based polymer of the present embodiment, a composition further improved in processability obtained when a filler and the like are compounded can be obtained.

The rubber softener is not especially limited, and examples include an extender oil, a liquid rubber, a resin or the like.

Examples of the extender oil include an aroma oil, a naphthenic oil and a paraffin oil. Among these, from the viewpoint of environmental safety, and from the viewpoint of oil bleeding prevention and improvement of wet grip performance, an aroma-alternative oil containing 3% by mass or less of a polycyclic aromatic (PCA) component according to the IP 346 is preferred. The aroma-alternative oil is not especially limited, and examples include TDAE (Threated Distillate Aromatic Extracts), and MES (Mild Extraction Solvate) mentioned in Kautschuk Gummi Kunststoffe 52 (12) 799 (1999), and RAE (Residual Aromatic Extracts).

The liquid rubber is not especially limited, and examples include liquid polybutadiene, and liquid styrene-butadiene rubber.

When a liquid rubber is used as the rubber softener, not only the above-described effect can be attained, but also the glass transition temperature of the resultant modified conjugated diene-based polymer composition can be lowered, and therefore, abrasion resistance, a low hysteresis loss property, and a low temperature characteristic of a vulcanizate obtained therefrom tend to be further improved.

The resin is not especially limited, and examples include an aromatic petroleum resin, a coumarone-indene resin, a terpene-based resin, a rosin derivative (including a wood oil resin), tall oil, a derivative of tall oil, a rosin ester resin, a natural or synthetic terpene resin, an aliphatic hydrocarbon resin, an aromatic hydrocarbon resin, a mixed aliphatic/aromatic hydrocarbon resin, a coumarin-indene resin, a phenol resin, a p-tert-butylphenol-acetylene resin, a phenol-formaldehyde resin, a xylene-formaldehyde resin, a monoolefin oligomer, a diolefin oligomer, an aromatic hydrocarbon resin, an aromatic petroleum resin, a hydrogenated aromatic hydrocarbon resin, a cyclic aliphatic hydrocarbon resin, a hydrogenated hydrocarbon resin, a hydrocarbon resin, a hydrogenated wood oil resin, a hydrogenated oil resin, and an ester of a hydrogenated oil resin and a monofunctional or polyfunctional alcohol. One of these resins may be singly used, or two or more of these may be used together. When such a resin is hydrogenated, all unsaturated groups may be hydrogenated, or some may be left not hydrogenated.

When a resin is used as the rubber softener, not only the above-described effect can be attained, but also fracture strength of a vulcanizate of the resultant modified conjugated diene-based polymer composition tends to be further improved.

The amount of the rubber softener to be added is not especially limited as long as it is 1.0 part by mass or more and 60 parts by mass or less with respect to 100 parts by mass of the modified conjugated diene-based polymer of the present embodiment, and is preferably 3.0 parts by mass or more and 50 parts by mass or less, and more preferably 5.0 parts by mass or more and 40 parts by mass or less, and further preferably 10 parts by mass or more and 35 parts by mass or less. When the rubber softener is added in an amount falling in the above-described range, there is a tendency that processability obtained with a filler and the like compounded is further better, and that fracture strength and abrasion resistance of a vulcanizate obtained therefrom are further better.

A method for adding the rubber softener to the modified conjugated diene-based polymer is not especially limited, and for example, a method in which the rubber softener is added to a solution of the modified conjugated diene-based polymer to be mixed, and the resultant polymer solution is desolvated can be employed.

From the viewpoint of preventing gel formation, and from the viewpoint of improving stability in processing, the modified conjugated diene-based polymer composition of the present embodiment may further contain a rubber stabilizer.

The rubber stabilizer is not especially limited, any of known ones can be used, and examples include antioxidants such as 2,6-di-tert-butyl-4-hydroxytoluene (hereinafter also referred to as “BHT”), n-octadecyl-3-(4′-hydroxy-3′,5′-di-tert-butylphenol)propionate, and 2-methyl-4,6-bis[(octylthio)methyl]phenol.

(Rubber Composition)

A rubber composition of the present embodiment comprises a rubber component containing 50 parts by mass or more of the modified conjugated diene-based polymer, and 5.0 parts by mass or more and 150 parts by mass or less of a filler with respect to 100 parts by mass of the rubber component. When the filler is dispersed in the rubber component containing the modified conjugated diene-based polymer of the present embodiment, a rubber composition further excellent in processability in vulcanization, and further excellent in a low hysteresis loss property, fracture performance, and abrasion resistance of a vulcanizate obtained therefrom can be obtained. When the rubber component contains the modified conjugated diene-based polymer composition of the present embodiment at a prescribed rate, low fuel composition performance, processability, and abrasion resistance are further improved.

The filler is not especially limited, and examples include a silica-based inorganic filler, carbon black, a metal oxide, and a metal hydroxide. Among these, a silica-based inorganic filler is preferred. In particular, when the rubber composition of the present embodiment is used in a tire, a vehicle component such as an anti-vibration rubber, or a vulcanized rubber for shoes or the like, a silica-based inorganic filler is particularly preferably contained. One of these fillers may be singly used, or two or more of these may be used together.

The silica-based inorganic filler is not especially limited, any of known fillers can be used, a solid particle containing SiO₂ or Si₃Al as a constituent unit is preferred, and a solid particle containing SiO₂ or Si₃Al as a principal component of a constituent unit is more preferred. Here, the principal component refers to a component contained in the silica-based inorganic filler in an amount of over 50% by mass, preferably 70% by mass or more, and more preferably 80% by mass or more.

A specific silica-based inorganic filler is not especially limited, and examples include silica, clay, talc, mica, diatomite, wollastonite, montmorillonite, zeolite and inorganic fibrous substances such as glass fiber. Alternatively, a silica-based inorganic filler having a hydrophobized surface, and a mixture of a silica-based inorganic filler and an inorganic filler except for silica may be used. Among these, from the viewpoint of further improving strength and abrasion resistance of the rubber composition, silica or glass fiber is preferred, and silica is more preferred. The silica is not especially limited, and examples include dry silica, wet silica and synthetic silicate silica.

Among these silica, wet silica is preferred from the viewpoint of further improving fracture strength of the resultant rubber composition.

From the viewpoint of more definitely obtaining a rubber composition having practically good abrasion resistance and fracture strength, a nitrogen adsorption specific surface area, obtained by the BET adsorption method, of the silica-based inorganic filler is preferably 100 m²/g or more and 300 m²/g or less, and more preferably 170 m²/g or more and 250 m²/g or less. Besides, a silica-based inorganic filler having a comparatively small specific surface area (for example, a specific surface area of 200 m²/g or less) and a silica-based inorganic filler having a comparatively large specific surface area (for example, 200 m²/g or more) can be used in combination if necessary. In the present embodiment, when a silica-based inorganic filler having a comparatively large specific surface area (of, for example, 200 m²/g or more) is used in particular, the modified conjugated diene-based polymer composition is particularly excellent in dispersibility of silica. As a result, the resultant rubber composition tends to have further excellent abrasion resistance, fracture strength, and low hysteresis loss property.

Carbon black is not especially limited, and examples include carbon blacks of SRF, FEF, HAF, ISAF and SAF classes. Among these, a carbon black having a nitrogen adsorption specific surface area of 50 m²/g or more and dibutyl phthalate (DBP) oil absorption of 80 mL/100 g or less is preferred.

The metal oxide is not especially limited as long as it is a solid particle containing a principal component of a constituent unit represented by chemical formula MₓO_{y} (wherein M represents a metal atom, and x and y each independently represent an integer of 1 to 6), and examples include alumina, titanium oxide, magnesium oxide, and zinc oxide.

The metal hydroxide is not especially limited, and examples include aluminum hydroxide, magnesium hydroxide, and zirconium hydroxide.

A content of the filler in the rubber composition of the present embodiment is preferably 5.0 parts by mass or more and 150 parts by mass, more preferably 20 parts by mass or more and 100 parts by mass or less, and further preferably 30 parts by mass or more and 90 parts by mass or less with respect to 100 parts by mass of the rubber component. When the filler is contained in the above-described range, there is a tendency that the rubber composition is further excellent in processability in vulcanization, and is further excellent in a low hysteresis loss property, fracture performance, and abrasion resistance of a vulcanizate obtained therefrom.

From the viewpoint of definitely imparting performances required in use as a tire or the like such as dry grip performance and conductivity, the rubber composition of the present embodiment preferably contains 0.5 parts by mass or more and 100 parts by mass or less of carbon black with respect to 100 parts by mass of the rubber component containing the modified conjugated diene-based polymer. From a similar viewpoint, the rubber composition contains carbon black in an amount of more preferably 3.0 parts by mass or more and 100 parts by mass or less, and further preferably 5.0 parts by mass or more and 50 parts by mass or less with respect to 100 parts by mass of the rubber component containing the modified conjugated diene-based polymer.

The rubber composition of the present embodiment may further contain a silane coupling agent. When the rubber composition contains a silane coupling agent, interaction between the rubber component and the filler can be further improved. The silane coupling agent is not especially limited, and is, for example, preferably a compound containing, in one molecule, a sulfur bond portion and an alkoxysilyl group or silanol group portion. Such a compound is not especially limited, and examples include bis-[3-(triethoxysilyl)-propyl]-tetrasulfide, bis-[3-(triethoxysilyl)-propyl]-disulfide and bis-[2-(triethoxysilyl)-ethyl]-tetrasulfide.

In the rubber composition of the present embodiment, a content of the silane coupling agent is preferably 0.1 parts by mass or more and 30 parts by mass or less, more preferably 0.5 parts by mass or more and 20 parts by mass or less, and further preferably 1.0 part by mass or more and 15 parts by mass or less with respect to 100 parts by mass of the filler. When the content of the silane coupling agent falls in the above-described range, there is a tendency that the interaction between the rubber component and the filler can be further improved.

The rubber composition of the present embodiment may contain, as the rubber component, a rubber-like polymer different from the modified conjugated diene-based polymer of the present embodiment (hereinafter simply referred to as the “rubber-like polymer”).

The rubber-like polymer is not especially limited, and examples include a conjugated diene-based polymer and a hydrogenated product thereof, a random copolymer of a conjugated diene-based compound and a vinyl aromatic compound, and a hydrogenated product thereof, a block copolymer of a conjugated diene-based compound and a vinyl aromatic compound, and a hydrogenated product thereof, a non-diene-based polymer and a natural rubber.

A specific rubber-like polymer is not especially limited, and examples include a butadiene rubber and a hydrogenated product thereof, an isoprene rubber and a hydrogenated product thereof, styrene-based elastomers such as a styrene-butadiene rubber and a hydrogenated product thereof, a styrene-butadiene block copolymer and a hydrogenated product thereof, and a styrene-isoprene block copolymer and a hydrogenated product thereof, and an acrylonitrile-butadiene rubber and a hydrogenated product thereof.

The non-diene-based polymer is not especially limited, and examples include olefin-based elastomers such as an ethylene-propylene rubber, an ethylene-propylene-diene rubber, an ethylene-butene-diene rubber, an ethylene-butene rubber, an ethylene-hexene rubber and an ethylene-octene rubber, a butyl rubber, a brominated butyl rubber, an acrylic rubber, a fluorine rubber, a silicone rubber, a chlorinated polyethylene rubber, an epichlorohydrin rubber, an α,β-unsaturated nitrile-acrylic acid ester-conjugated diene copolymer rubber, a urethane rubber and a polysulfide rubber.

The natural rubber is not especially limited, and examples include smoked sheets of RSS Nos. 3 to 5, SMR and epoxidized natural rubber.

The rubber-like polymer may be in the form of a modified rubber imparted with a functional group having polarity such as a hydroxyl group or an amino group. When the rubber composition of the present invention is used in a tire, the rubber-like polymer is preferably one or more selected from the group consisting of a butadiene rubber, an isoprene rubber, a styrene-butadiene rubber, a natural rubber and a butyl rubber.

The weight average molecular weight (Mw) of the rubber-like polymer is preferably 2,000 or more and 2,000,000 or less, and more preferably 5,000 or more and 1,500,000 or less from the viewpoints of abrasion resistance, fracture strength, and balance between a low hysteresis loss property and processability of the resultant rubber composition. As the rubber-like polymer, a low molecular weight rubber-like polymer, that is, what is called a liquid rubber, can be used. One of these rubber-like polymers may be singly used, or two or more of these may be used together.

When the rubber composition of the present embodiment contains the modified conjugated diene-based polymer of the present embodiment and the rubber-like polymer, a content ratio (in a mass ratio) of the modified conjugated diene-based polymer to the rubber-like polymer is, in terms of (the modified conjugated diene-based polymer/the rubber-like polymer), preferably 50/50 or more and 100/0 or less, more preferably 55/45 or more and 95/5 or less, further preferably 60/40 or more and 90/10 or less, and particularly preferably 65/35 or more and 85/15 or less. In other words, the rubber component contains, with respect to 100 parts by mass of the total amount of the rubber component, preferably 50 parts by mass or more and 100 parts by mass or less, more preferably 55 parts by mass or more and 95 parts by mass or less, further preferably 60 parts by mass or more and 90 parts by mass or less, and particularly preferably 65 parts by mass or more and 85 parts by mass or less of the modified conjugated diene-based polymer of the present embodiment. When the ratio of the conjugated diene-based polymer contained in the rubber component falls in the above-described range, a vulcanizate of the rubber composition tends to be further excellent in abrasion resistance and a low hysteresis loss property.

The rubber composition of the present embodiment may contain a rubber softener in addition to the rubber component from the viewpoint of further improving the processability.

As the rubber softener, the same ones as those described as examples to be contained in the conjugated diene-based polymer composition can be used, and a mineral oil, or a liquid or low molecular weight synthetic softener is suitable.

A mineral oil-based rubber softener, which is used for softening, expanding and improving processability of a rubber and is designated as a process oil or an extender oil, is a mixture of an aromatic ring, a naphthene ring and a paraffin chain. In particular, one in which the number of carbon atoms of the paraffin chain is 50% or more is designated as a paraffin-based softener, one in which the number of carbon atoms of the naphthene ring is 30% or more and 45% or less is designated as a naphthene-based softener, and one in which the number of carbon atoms belonging to aromatic carbons exceeds 30% of the number of all carbon atoms is designated as an aromatic-based softener. The rubber composition of the present embodiment preferably contains, as a rubber softener, one having an appropriate aromatic content. When such a rubber softener is contained, compatibility with the modified conjugated diene-based polymer is further improved.

The content of the rubber softener in the rubber composition is expressed as a sum of the amount of the rubber softener precedently added to the modified conjugated diene-based polymer composition or the rubber-like polymer, and the amount of the rubber softener added in forming the rubber composition.

In the rubber composition of the present embodiment, the content of the rubber softener is preferably 0 part by mass or more and 100 parts by mass or less, more preferably 10 parts by mass or more and 90 parts by mass or less, and further preferably 30 parts by mass or more and 90 parts by mass or less with respect to 100 parts by mass of the rubber component. When the content of the rubber softener is 100 parts by mass or less with respect to 100 parts by mass of rubber component, bleeding out can be suppressed, and the stickiness of the surface of the rubber composition can be further suppressed.

A method for mixing the modified conjugated diene-based polymer, the modified conjugated diene-based polymer composition, the rubber-like polymer, the filler, the silane coupling agent, and/or the rubber softener and the like is not especially limited, and examples include a melt-kneading method using a general mixer such as an open roll, a Banbury mixer, a kneader, a single shaft screw extruder, a twin shaft screw extruder or a multi-shaft screw extruder, and a method in which the respective components are melted and mixed followed by removal of a solvent by heating. Among these methods, the melt-kneading method using a roll, a Banbury mixer, a kneader or an extruder is preferred from the viewpoint of productivity and high kneadability. Besides, the rubber component, the filler, the silane coupling agent, and the additive may be kneaded all together, or may be mixed dividedly in plural times.

The rubber composition of the present embodiment may be in the form of a vulcanizate obtained by vulcanization with a vulcanizing agent. The vulcanizing agent is not especially limited, and examples include radical generators such as organic peroxides and azo compounds, oxime compounds, nitroso compounds, polyamine compounds, sulfur and sulfur compounds. The sulfur compounds encompass sulfur monochloride, sulfur dichloride, disulfide compounds, high molecular weight polysulfide compounds and the like.

In the rubber composition of the present embodiment, the content of the vulcanizing agent is, but is not especially limited to, preferably 0.01 parts by mass or more and 20 parts by mass or less, and more preferably 0.1 parts by mass or more and 15 parts by mass or less with respect to 100 parts by mass of the rubber component. As a vulcanization method, any of conventionally known methods can be employed. A vulcanization temperature is preferably 120° C. or more and 200° C. or less, and more preferably 140° C. or more and 180° C. or less.

For the vulcanization of the rubber composition, a vulcanization accelerator and/or a vulcanization aid may be used if necessary. As the vulcanization accelerator, any of conventionally known materials can be used, and examples include, but are not especially limited to, sulphenamide-based, guanidine-based, thiuram-based, aldehyde-amine-based, aldehyde-ammonia-based, thiazole-based, thiourea-based and dithiocarbamate-based vulcanization accelerators. Besides, the vulcanization aid is not especially limited, and examples include zinc oxide and stearic acid. The contents of the vulcanization accelerator and the vulcanization aid are, but are not especially limited to, respectively preferably 0.01 parts by mass or more and 20 parts by mass or less, and more preferably 0.1 parts by mass or more and 15 parts by mass or less with respect to 100 parts by mass of the rubber component.

The rubber composition of the present embodiment may contain, as long as the effects of the present embodiment are not impaired, various additives and the like such as another softener and filler excluding those described above, a heat resistance stabilizer, an antistatic agent, a weathering stabilizer, an anti-aging agent, a colorant and a lubricant. As the softener, any of known softeners can be used. The filler is not especially limited, and specific examples include calcium carbonate, magnesium carbonate, aluminum sulfate and barium sulfate. As the heat resistance stabilizer, the antistatic agent, the weathering stabilizer, the anti-aging agent, the colorant and the lubricant, any of known materials can be respectively used.

The rubber composition of the present embodiment is suitably used as a rubber composition for a tire. The rubber composition of the present embodiment can be suitably used in, but not especially limited to, various tires such as a fuel-efficient tire, an all-season tire, a high-performance tire and a studless tire; and various tire portions such as a tread, a carcass, a sidewall and a bead.

It is noted that each numerical range described above as a preferable range or the like may be a numerical range obtained by arbitrarily combining any one of values described as the upper limits and any one of values described as the lower limits even when not particularly stated.

### EXAMPLES

The present embodiment will now be described in more detail with reference to specific examples and comparative examples, and it is noted that the present invention is not limited to the following examples and comparative examples at all.

Various physical properties of the examples and comparative examples were measured by the following methods.

(Physical Property 1) Average Molecular Weight Measured by GPC Measurement

A modified conjugated diene-based polymer was used as a sample for performing GPC measurement using a GPC measurement apparatus (trade name “HLC-8320GPC” manufactured by Tosoh Corporation) including a series of three columns using a polystyrene-based gel as a filler, and an RI detector (trade name “HLC8020” manufactured by Tosoh Corporation). On the basis of a calibration curve obtained using standard polystyrene, a weight average molecular weight (Mw), a number average molecular weight (Mn) and a molecular weight distribution (Mw/Mn) which was a ratio therebetween were each obtained.

As an eluent, a 5 mmol/L triethylamine-THF (tetrahydrofuran) solution was used. As the columns, trade name “TSKguardcolumn Super MP(HZ)-H” manufactured by Tosoh Corporation connected, as a guard column at a previous stage, to a series of three columns of trade name “TSKgel Super Multipore HZ-H” manufactured by Tosoh Corporation were used.

Ten (10) mg of a sample for the measurement was dissolved in 10 mL of THF to obtain a measurement solution, and 10 μL of the measurement solution was injected into the GPC measurement apparatus for performing the measurement under conditions of an oven temperature of 40° C. and a THF flow rate of 0.35 mL/min.

Measurement results thus obtained were defined as the respective average molecular weights of the sample.

(Physical Property 2) Mooney Viscosity of Polymer

A modified conjugated diene-based polymer was used as a sample to measure a Mooney viscosity by using a Mooney viscometer (trade name “VR1132” manufactured by Ueshima Seisakusho Co., Ltd.) in accordance with ISO 289 with an L-type rotor used. A measurement temperature was 100° C. Here, after a sample was preheated at the test temperature for 1 minute, the rotor was rotated at 2 rpm, and a torque was measured 4 minutes after to measure a Mooney viscosity (ML₍₁₊₄₎, 100° C.).

(Physical Property 3) Mooney Stress Relaxation Rate

A modified conjugated diene-based polymer was used as a sample to measure the above-described Mooney viscosity by using a Mooney viscometer (trade name “VR1132” manufactured by Ueshima Seisakusho Co., Ltd.) in accordance with ISO 289 with an L-type rotor used. Immediately thereafter, the rotation of the rotor was stopped, and a torque was recorded in a Mooney unit every 0.1 second from 1.6 seconds to 5 seconds after stop. A slope of a straight line in a double logarithm plot of the torque and the time (sec) was determined, and an absolute value thereof was regarded as a Mooney stress relaxation rate (MSR, 100° C.).

(Physical Property 4) Silicon Content

A content of Si (silicon) was measured using an inductively coupled plasma optical emission spectrometer (ICP-OES; Optima 7300DV) as an ICP analysis method. When the inductively coupled plasma optical emission spectrometer was used, approximately 0.7 g of a sample was placed in a platinum crucible, then approximately 1 mL of concentrated sulfuric acid (98% by weight) was placed therein, and the sample was heated at 300° C. for 3 hours and allowed to undergo ashing under a program of the following 1 to 3 in an electric furnace.

1) Step 1: An initial temperature of 0° C., temperature increase at 180° C./hr, and then heat retention at 180° C. for 1 hour
2) Step 2: Temperature increase at 85° C./hr from 180° C., and then heat retention at 370° C. for 2 hours
3) Step 3: Temperature increase at 47° C./hr from 370° C., and then heat retention at 510° C. for 3 hours

1 mL of concentrated sulfuric acid (48% by weight) and 20 μl of concentrated fluoric acid (50% by weight) were added to the residue, and the platinum crucible was hermetically sealed and shaken for 30 minutes. Then, 1 mL of boric acid was added to the sample, which was stored at 0° C. for 2 hours or more, then diluted with 30 mL of ultrapure water, and allowed to undergo ashing, followed by measuring the content of Si (silicon).

(Physical Property 5) Nitrogen Content

A content of N (nitrogen) was measured using a trace nitrogen quantitative analyzer (NSX-2100H). When the trace nitrogen quantitative analyzer was used, the trace nitrogen quantitative analyzer was turned on. After Ar was set to 250 ml/min, O₂ was set to 350 ml/min, a carrier gas flow rate was set to 300 ml/min in an ozonizer, and a heater was set to 800° C., the analyzer was stabilized by waiting for approximately 3 hours. After the analyzer was thus stabilized, a calibration curve was prepared in a calibration curve range of 5 ppm, 10 ppm, 50 ppm, 100 ppm, and 500 ppm using standard samples, and an area corresponding to each concentration was obtained, followed by preparing a straight line using the ratios between the concentrations and the areas. Then, a ceramic boat containing 20 mg of a sample was placed in Auto sampler of the analyzer and measured to obtain an area. The content of N (nitrogen) was calculated using the obtained area of the sample and the calibration curve. In this respect, the sample was a modified conjugated diene-based polymer from which a solvent was removed by placement in hot water heated with steam, and stirring, and thus, a residual monomer, a residual modifier, and an oil were removed therefrom.

(Physical Property 6) Modification Ratio

A modification ratio of a modified conjugated diene-based polymer was measured by column adsorption GPC as follows. Column adsorption GPC is a method for obtaining a modification ratio of a modified conjugated diene-based polymer by utilizing a characteristic that a modified basic polymer component of the modified conjugated diene-based polymer easily adsorbs onto a GPC column using a silica-based gel as a filler.

A modified conjugated diene-based polymer was used as a sample to measure a sample solution containing the sample and low molecular weight internal standard polystyrene with a polystyrene-based column. Besides, the same sample solution was measured with a silica-based column. A difference between a chromatogram obtained by the measurement with the polystyrene-based column and a chromatogram obtained by the measurement with the silica-based column was obtained to measure the amount of the modified conjugated diene-based polymer adsorbed onto the silica-based column, and thus, a modification ratio was obtained.

Specifically, Ten (10) mg of a sample and 5 mg of standard polystyrene were dissolved in 20 mL of THF to obtain a sample solution. A modification ratio of a modified conjugated diene-based polymer was measured under the following measurement conditions:

(GPC Measurement Conditions in Using Polystyrene-Based Column)

The GPC measurement was performed using an apparatus of trade name “HLC-8320GPC” manufactured by Tosoh Corporation and a reflex index (RI) detector (trade name “HLC8020” manufactured by Tosoh Corporation).

A 5 mmol/L triethylamine-THF solution was used as an eluent, and 10 μL of a sample solution was injected into the GPC apparatus to obtain a chromatogram under conditions of a column oven temperature of 40° C. and a THF flow rate of 0.35 mL/min.

As the columns, a series of three columns of trade name “TSKgel Super Multipore HZ-H” manufactured by Tosoh Corporation were connected with a column of trade name “TSKguardcolumn SuperMP(HZ)-H” manufactured by Tosoh Corporation connected as a guard column at a previous stage to be used.

(GPC Measurement Conditions Using Silica-Based Column)

The GPC measurement was performed using an apparatus of trade name “HLC-8320GPC” manufactured by Tosoh Corporation and an RI detector (trade name “HLC8020” manufactured by Tosoh Corporation).

THF was used as an eluent, and 50 μL of a sample solution was injected into the GPC apparatus to obtain a chromatogram under conditions of a column oven temperature of 40° C. and a THF flow rate of 0.5 mL/min.

A series of columns of trade names “Zorbax PSM-1000S”, “PSM-300S” and “PSM-60S” manufactured by Agilent Technologies Japan Ltd., and a guard column of trade name “DIOL 4.6×12.5 mm 5 micron” connected at a previous stage were used.

Calculation method for modification ratio: In the chromatogram obtained by using the polystyrene-based column, assuming that the whole peak area was 100, a peak area P1 of the sample and a peak area P2 of standard polystyrene were obtained. Besides, in the chromatogram obtained by using the silica-based column, assuming that the whole peak area was 100, a peak area P3 of the sample and that a peak area P4 of standard polystyrene were obtained. Then, a modification ratio (%) was obtained in accordance with the following expression:

Modification ratio (%)=[1−(P2×P3)/(P1×P4)]×100

wherein P1+P2=P3+P4=100

(Physical Property 7) Bound Aromatic Vinyl Content (Amount of Bound Styrene)

A modified conjugated diene-based polymer was used as a sample, and 100 mg of the sample was dissolved in 100 mL of chloroform to obtain a measurement sample. Each sample was measured with a spectrophotometer (trade name “UV-2450” manufactured by Shimadzu Corporation) to obtain an absorption spectrum. Based on absorbance of UV light (in the vicinity of 254 nm) derived from a phenyl group of styrene, the amount of bound styrene (% by mass) in 100% by mass of the modified conjugated diene-based polymer was calculated.

(Physical Property 7) Vinyl Bond Content in Bound Conjugated Diene (Amount of 1,2-Vinyl Bond in Bound Butadiene)

A modified conjugated diene-based polymer was used as a sample, and 50 mg of the sample was dissolved in 10 mL of carbon disulfide to obtain a measurement sample. An infrared spectrum of each sample was measured in a range of 600 to 1,000 cm-1 with Fourier transform infrared spectrophotometer (trade name “FT-IR230” manufactured by JASCO Corporation). In accordance with the Hampton method (method described by R. R. Hampton, Analytical Chemistry 21, 923 (1949)), an amount of 1,2-vinyl bond (mol %) in bound butadiene was obtained based on absorbance at a prescribed wavelength.

(Physical Property 8) Glass Transition Temperature

A modified conjugated diene-based polymer was used as a sample to perform DSC measurement in accordance with ISO 22768: 2006 with a differential scanning calorimeter (trade name “DSC 3200S” manufactured by Mac Science). A DSC curve was recorded with the temperature increased from −100° C. at 20° C./min under a flow of 50 mL/min of helium, and a peak top (infection point) in a DSC differential curve thus obtained was defined as the glass transition temperature Tg.

(Physical Property 9) Phase Difference Index

Approximately 6 g of a modified conjugated diene-based polymer was prepared as a sample, and each sample was measured using RUBBER PROCESS ANALYZER RPA2000 manufactured by Alpha Technologies Inc. to determine a tan δ value at 0.1 Hz measured at 160° C. and strain of 7% as a phase difference index.

### (Example 1) Modified Conjugated Diene-Based Polymer (A1)

Two tank pressure vessels, each of which had an internal volume of 10 L and a ratio (L/D) of internal height (L) and diameter (D) of 4.0, had an inlet at a bottom and an outlet at a top, and was equipped with a stirrer and a temperature controlling jacket, were connected to each other as polymerizing branching reactors. 1,3-Butadiene, styrene and n-hexane, from which a water content had been precedently removed, were mixed under conditions of 22.3 g/min, 3.4 g/min and 100.4 g/min, respectively to be continuously supplied to the bottom of the first reactor. In this supply, immediately before the mixed solution entered the first reactor, n-butyllithium to be used for residual impurity inactivation was continuously added under a condition of 0.104 mmol/min while being mixed with a static mixer. Besides, at the same time as the supply of 1,3-butadiene, styrene, n-hexane, and n-butyllithium, 2,2-bis(2-oxolanyl)propane used as a polar material and n-butyllithium used as a polymerization initiator were supplied under conditions of respectively 0.094 mmol/min and 0.234 mmol/min to the bottom of the first reactor in which reaction solutions were vigorously stirred with the stirrer. It is noted that the internal temperature of the first reactor was kept at 68° C.

A conjugated diene-based polymer solution generated through a polymerization reaction caused in the first reactor was continuously taken out from the top of the first reactor to be continuously supplied to the bottom of the second reactor. It is noted that the solution continuously taken out from the top of the first reactor had been sufficiently stably polymerized. Simultaneously with supply of the conjugated diene-based polymer solution, trimethoxy(4-vinylphenyl)silane (shown as “al” in Table 1) as the branching agent was supplied from the bottom of the second reactor under a condition of 0.012 mmol/min. In addition, additional 1,3-butadiene was added under a condition of 7.4 g/min. It is noted that the internal temperature of the second reactor was kept at 73° C. A small amount of the conjugated diene-based polymer solution was taken out from the outlet of the second reactor, an antioxidant (BHT) was added thereto to obtain an amount of 0.2 g per 100 g of the conjugated diene-based polymer, and then the solvent was removed after adding the antioxidant (BHT).

Next, a conjugated diene-based polymer solution having a branch structure generated through a branching reaction caused in the second reactor was continuously taken out from the top of the second reactor to be continuously supplied to the bottom of the second reactor. To the polymer solution continuously flowing to a static mixer, tetrakis(3-trimethoxysilylpropyl)-1,3-propanediamine (shown as “b1” in Table 1) and 1-methyl-4-[3-(trimethoxysilyl)propyl]piperazine (shown as “b2” in Table 1) were continuously added as a coupling modifier under a condition of 0.011 mmol/min and 0.102 mmol/min, respectively, and thus, the conjugated diene-based polymer having a branch structure was coupled. Here, a time until the addition of the coupling modifier to the polymer solution flowing out of the outlet of the second reactor was 4.8 min, the temperature of the polymer solution at which the coupling modifier was added was 68° C. Besides, a difference between the temperature of the polymer solution at the outlet of the second reactor and the temperature of the polymer solution in adding the coupling modifier was 2° C. A small amount of the modified conjugated diene-based polymer solution after the coupling was taken out, an antioxidant (BHT) was added thereto to obtain an amount of 0.2 g per 100 g of the modified conjugated diene-based polymer, and then the solvent was removed. The amount of bound styrene (Physical Property 7) and the amount of 1,2-vinyl bond in bound butadiene (Physical Property 7) of the thus obtained modified conjugated diene-based polymer were measured. Measurement results are shown in Table 1.

Next, to the polymer solution flowing out of the static mixer, a solution of an antioxidant (BHT) in n-hexane was added to obtain an amount of the antioxidant (BHT) of 0.2 g per 100 g of the modified conjugated diene-based polymer continuously under a condition of 0.055 g/min to complete the coupling reaction. The solvent was removed by steam stripping, and thus, a modified conjugated diene-based polymer (A1) was obtained. Physical properties of the modified conjugated diene-based polymer (A1) are shown in Table 1.

### (Example 2) Modified Conjugated Diene-Based Polymer (A2)

A modified conjugated diene-based polymer (A2) was obtained in the same manner as in Example 1 except that 1,3-butadiene was supplied under a condition of 17.3 g/min, that styrene was supplied under a condition of 6.5 g/min, that n-butyllithium as the polymerization initiator was supplied under a condition of 0.239 mmol/min, that additional 1,3-butadiene was supplied under a condition of 5.8 g/min, and that b2 as the coupling modifier was supplied under a condition of 0.105 mmol/min. Physical properties of the modified conjugated diene-based polymer (A2) are shown in Table 1.

### (Example 3) Modified Conjugated Diene-Based Polymer (A3)

A modified conjugated diene-based polymer (A3) was obtained in the same manner as in Example 2 except that 1,3-butadiene was supplied under a condition of 22.3 g/min, that styrene was supplied under a condition of 3.4 g/min, that additional 1,3-butadiene was supplied under a condition of 7.4 g/min, that 2,2-bis(2-oxolanyl)propane as the polar compound was supplied under a condition of 0.062 mmol/min, that the temperature of the first reactor was changed to 82° C., and that the temperature of the second reactor was changed to 86° C. Physical properties of the modified conjugated diene-based polymer (A3) are shown in Table 1.

### (Example 4) Modified Conjugated Diene-Based Polymer (A4)

Two tank pressure vessels, each of which had an internal volume of 10 L and a ratio (L/D) of internal height (L) and diameter (D) of 4.0, had an inlet at a bottom and an outlet at a top, and was equipped with a stirrer and a temperature controlling jacket, were connected to each other as polymerization reactors.

1,3-Butadiene, styrene and n-hexane, from which a water content had been precedently removed, were mixed under conditions of 22.3 g/min, 3.4 g/min and 100.4 g/min, respectively to be continuously supplied to the bottom of the first reactor. In this supply, immediately before the mixed solution entered the first reactor, n-butyllithium to be used for residual impurity inactivation was continuously added under a condition of 0.104 mmol/min while being mixed with a static mixer. Besides, at the same time as the supply of 1,3-butadiene, styrene, n-hexane, and n-butyllithium, 2,2-bis(2-oxolanyl)propane used as the polar material and n-butyllithium used as the polymerization initiator were supplied under conditions of respectively 0.094 mmol/min and 0.234 mmol/min to the bottom of the first reactor in which reaction materials were vigorously stirred with the stirrer. It is noted that the internal temperature of the first reactor was kept at 68° C.

A conjugated diene-based polymer solution generated through a polymerization reaction caused in the first reactor was continuously taken out from the top of the first reactor to be continuously supplied to the bottom of the second reactor. In addition, additional 1,3-butadiene was added under a condition of 7.4 g/min. It is noted that the internal temperature of the second reactor was kept at 73° C. A small amount of the conjugated diene-based polymer solution was taken out from the outlet of the second reactor, an antioxidant (BHT) was added thereto to obtain an amount of the antioxidant (BHT) of 0.2 g per 100 g of the conjugated diene-based polymer, and then the solvent was removed.

Next, a conjugated diene-based polymer solution generated in the second reactor was continuously taken out from the top of the second reactor to be continuously supplied to the bottom of the second reactor. To the polymer solution continuously flowing to a static mixer, tetrakis(3-trimethoxysilylpropyl)-1,3-propanediamine (shown as “b1” in Table 1) and 1-methyl-4-[3-(trimethoxysilyl)propyl]piperazine (shown as “b2” in Table 1) were continuously added as a coupling modifier under a condition of 0.019 mmol/min and 0.075 mmol/min, respectively, and thus, the conjugated diene-based polymer was coupled. Here, a time until the addition of the coupling modifier to the polymer solution flowing out of the outlet of the second reactor was 4.8 min, the temperature of the polymer solution at which the coupling modifier was added was 68° C. Besides, a difference between the temperature of the polymer solution at the outlet of the second reactor and the temperature of the polymer solution in adding the coupling modifier was 2° C.

A small amount of the modified conjugated diene-based polymer solution after the coupling was taken out, an antioxidant (BHT) was added thereto to obtain an amount of 0.2 g per 100 g of the modified conjugated diene-based polymer, and then the solvent was removed. The amount of bound styrene (Physical Property 7) and the amount of 1,2-vinyl bond in bound butadiene (Physical Property 7) of the thus obtained modified conjugated diene-based polymer were measured. Measurement results are shown in Table 1.

Next, to the polymer solution flowing out of the static mixer, a solution of an antioxidant (BHT) in n-hexane was added to obtain an amount of the antioxidant (BHT) of 0.2 g per 100 g of the modified conjugated diene-based polymer continuously under a condition of 0.055 g/min to complete the coupling reaction. The solvent was removed by steam stripping, and thus, a modified conjugated diene-based polymer (A4) was obtained. Physical properties of the modified conjugated diene-based polymer (A4) are shown in Table 1. The structure of the modified conjugated diene-based polymer was identified as to the polymer after the addition of the coupling modifier. Hereinafter, the structure of each sample was similarly identified.

### (Example 5) Modified Conjugated Diene-Based Polymer (A5)

A modified conjugated diene-based polymer (A5) was obtained in the same manner as in Example 1 except that 2,2-bis(2-oxolanyl)propane as the polar compound was supplied under a condition of 0.152 mmol/min. Physical properties of the modified conjugated diene-based polymer (A5) are shown in Table 1.

### (Example 6) Modified Conjugated Diene-Based Polymer (A6)

A modified conjugated diene-based polymer (A6) was obtained in the same manner as in Example 1 except that n-butyllithium as the polymerization initiator was supplied under a condition of 0.219 mmol/min. Physical properties of the modified conjugated diene-based polymer (A6) are shown in Table 1.

### (Example 7) Modified Conjugated Diene-Based Polymer (A7)

A modified conjugated diene-based polymer (A7) was obtained in the same manner as in Example 1 except that tetrakis(3-trimethoxysilylpropyl)-1,3propanediamine (shown as “b1” in Table 1) and 1-methyl-4-[3-(trimethoxysilyl)propyl]piperazine (shown as “b2” in Table 1) were supplied as the coupling modifier under a condition of 0.007 mmol/min and 0.117 mmol/min, respectively. Physical properties of the modified conjugated diene-based polymer (A7) are shown in Table 1.

### (Example 8) Modified Conjugated Diene-Based Polymer (A8)

A modified conjugated diene-based polymer (A8) was obtained in the same manner as in Example 7 except that 1,3-butadiene was supplied under a condition of 17.3 g/min, that styrene was supplied under a condition of 6.5 g/min, and that additional butadiene was supplied under a condition of 5.8 g/min. Physical properties of the modified conjugated diene-based polymer (A8) are shown in Table 1.

### (Example 9) Modified Conjugated Diene-Based Polymer (A9)

A modified conjugated diene-based polymer (A9) was obtained in the same manner as in Example 1 except that n-butyllithium as the polymerization initiator was supplied under a condition of 0.224 mmol/min, and that tetrakis(3-trimethoxysilylpropyl)-1,3-propanediamine (shown as “b1” in Table 1) and 1-methyl-4-[3-(trimethoxysilyl)propyl]piperazine (shown as “b2” in Table 1) were supplied as the coupling modifier under a condition of 0.010 mmol/min and 0.087 mmol/min, respectively. Physical properties of the modified conjugated diene-based polymer (A9) are shown in Table 1.

### (Example 10) Modified Conjugated Diene-Based Polymer (A10)

A modified conjugated diene-based polymer (A10) was obtained in the same manner as in Example 9 except that tetrakis(3-trimethoxysilylpropyl)-1,3-propanediamine (shown as “b1” in Table 1) and 1-methyl-4-[3-(trimethoxysilyl)propyl]piperazine (shown as “b2” in Table 1) were supplied as the coupling modifier under a condition of 0.009 mmol/min and 0.082 mmol/min, respectively. Physical properties of the modified conjugated diene-based polymer (A10) are shown in Table 1.

### (Example 11) Modified Conjugated Diene-Based Polymer (A11)

A modified conjugated diene-based polymer (A11) was obtained in the same manner as in Example 9 except that tetrakis(3-trimethoxysilylpropyl)-1,3-propanediamine (shown as “b1” in Table 1) and 1-methyl-4-[3-(trimethoxysilyl)propyl]piperazine (shown as “b2” in Table 1) were supplied as the coupling modifier under a condition of 0.009 mmol/min and 0.080 mmol/min, respectively. Physical properties of the modified conjugated diene-based polymer (A11) are shown in Table 1.

### (Comparative Example 1) Modified Conjugated Diene-Based Polymer (B1)

A modified conjugated diene-based polymer (B1) was obtained in the same manner as in Example 4 except that n-butyllithium as the polymerization initiator was supplied under a condition of 0.302 mmol/min, and that only 1-methyl-4-[3-(trimethoxysilyl)propyl]piperazine (shown as “b2” in Table 1) was supplied as the coupling modifier under a condition of 0.150 mmol/min without the use of tetrakis(3-trimethoxysilylpropyl)-1,3-propanediamine (shown as “b1” in Table 1). Physical properties of the modified conjugated diene-based polymer (B1) are shown in Table 1.

### (Comparative Example 2) Modified Conjugated Diene-Based Polymer (B2)

A modified conjugated diene-based polymer (B2) was obtained in the same manner as in Example 2 except that 1,3-butadiene was supplied under a condition of 16.1 g/min, that styrene was supplied under a condition of 11.8 g/min, and that 2,2-bis(2-oxolanyl)propane as the polar compound was supplied under a condition of 0.127 mmol/min, and that in addition, additional 1,3-butadiene was supplied under a condition of 5.4 g/min. Physical properties of the modified conjugated diene-based polymer (B2) are shown in Table 1.

### (Comparative Example 3) Modified Conjugated Diene-Based Polymer (B3)

A modified conjugated diene-based polymer (B3) was obtained in the same manner as in Comparative Example 1 except that n-butyllithium as the polymerization initiator was supplied under a condition of 0.234 mmol/min, and that tetraalkoxysilane (shown as “b3” in Table 1) was supplied as the coupling modifier instead of 1-methyl-4-[3-(trimethoxysilyl)propyl]piperazine (shown as “b2” in Table 1) under a condition of 0.075 mmol/min. Physical properties of the modified conjugated diene-based polymer (B3) are shown in Table 1.

### (Comparative Example 4) Modified Conjugated Diene-Based Polymer (B4)

A modified conjugated diene-based polymer (B4) was obtained in the same manner as in Example 3 except that n-butyllithium as the polymerization initiator was supplied under a condition of 0.265 mmol/min, that 2,2-bis(2-oxolanyl)propane as the polar compound was supplied under a condition of 0.062 mmol/min, that trimethoxy(4-vinylphenyl)silane (shown as “al” in Table 1) as the branching agent was supplied under a condition of 0.014 mmol/min, and that tetrakis(3-trimethoxysilylpropyl)-1,3-propanediamine (shown as “b1” in Table 1) and 1-methyl-4-[3-(trimethoxysilyl)propyl]piperazine (shown as “b2” in Table 1) were continuously supplied as the coupling modifier under a condition of 0.012 mmol/min and 0.116 mmol/min, respectively. Physical properties of the modified conjugated diene-based polymer (B4) are shown in Table 1.

### (Comparative Example 5) Modified Conjugated Diene-Based Polymer (B5)

A modified conjugated diene-based polymer (B5) was obtained in the same manner as in Comparative Example 1 except that n-butyllithium as the polymerization initiator was supplied under a condition of 0.271 mmol/min, and that 1-methyl-4-[3-(trimethoxysilyl)propyl]piperazine (shown as “b2” in Table 1) was supplied as the coupling modifier under a condition of 0.140 mmol/min. Physical properties of the modified conjugated diene-based polymer (B5) are shown in Table 1.

### (Comparative Example 6) Modified Conjugated Diene-Based Polymer (B6)

A modified conjugated diene-based polymer (B6) was obtained in the same manner as in Example 3 except that tetrakis(3-trimethoxysilylpropyl)-1,3-propanediamine (shown as “b1” in Table 1) and 1-methyl-4-[3-(trimethoxysilyl)propyl]piperazine (shown as “b2” in Table 1) were continuously supplied as the coupling modifier under a condition of 0.018 mmol/min and 0.075 mmol/min, respectively. Physical properties of the modified conjugated diene-based polymer (B6) are shown in Table 1.

### (Comparative Example 7) Modified Conjugated Diene-Based Polymer (B7)

A modified conjugated diene-based polymer (B7) was obtained in the same manner as in Example 1 except that n-butyllithium as the polymerization initiator was supplied under a condition of 0.219 mmol/min, and tetrakis(3-trimethoxysilylpropyl)-1,3-propanediamine (shown as “b1” in Table 1) and 1-methyl-4-[3-(trimethoxysilyl)propyl]piperazine (shown as “b2” in Table 1) were continuously supplied under a condition of 0.008 mmol/min and 0.077 mmol/min, respectively. Physical properties of the modified conjugated diene-based polymer (B7) are shown in Table 1.

TABLE 1

| | | | | Ex. 1 | Ex. 2 | Ex. 3 | Ex. 4 | Ex. 5 | Ex. 6 |
|---|---|---|---|---|---|---|---|---|---|
| Modified Conjugated Diene-based Polymer | | | −5 | A1 | A2 | A3 | A4 | A5 | A6 |
| Poly- | Butadiene | | (g/min) | 22.3 | 17.3 | 22.3 | 22.3 | 22.3 | 22.3 |
| merization | Styrene | | (g/min) | 3.4 | 6.5 | 3.4 | 3.4 | 3.4 | 3.4 |
| Conditions | n-Hexane | | (g/min) | 100.4 | 100.4 | 100.4 | 100.4 | 100.4 | 100.4 |
| | n-Butyllithium for | | (mmol/ | 0.104 | 0.104 | 0.104 | 0.104 | 0.104 | 0.104 |
| | Impurity Treatment | | min) | | | | | | |
| | n-Butyllithium of | | (mmol/ | 0.234 | 0.239 | 0.239 | 0.234 | 0.234 | 0.219 |
| | Polymerization Initiator | | min) | | | | | | |
| | Polar Compound | | (mmol/ | 0.094 | 0.094 | 0.062 | 0.094 | 0.152 | 0.094 |
| | | | min) | | | | | | |
| | Additional Butadiene | | (g/min) | 7.4 | 5.8 | 7.4 | 7.4 | 7.4 | 7.4 |
| | Branching | Used or not | — | a1 | a1 | a1 | — | a1 | a1 |
| | Agent | Amount Added | (mmol/ | 0.012 | 0.012 | 0.012 | — | 0.012 | 0.012 |
| | | | min) | | | | | | |
| | Coupling | Type | — | b1 | b1 | b1 | b1 | b1 | b1 |
| | Modifier | Amount Added | (mmol/ | 0.011 | 0.011 | 0.011 | 0.019 | 0.011 | 0.011 |
| | | | min) | | | | | | |
| | | Type | — | b2 | b2 | b2 | b2 | b2 | b2 |
| | | Amount Added | (mmol/ | 0.102 | 0.105 | 0.105 | 0.075 | 0.102 | 0.102 |
| | | | min) | | | | | | |
| | Modified | (Physical Property 1) | (g/mol) | 345,000 | 333,000 | 333,000 | 320,000 | 345,000 | 356,000 |
| | Conjugated | Number Average | | | | | | | |
| | Diene- | Molecular Weight | | | | | | | |
| | based | (Physical Property 1) | (g/mol) | 620,000 | 600,000 | 600,000 | 570,000 | 620,000 | 640,000 |
| | Polymer | Weight Average | | | | | | | |
| | | Molecular Weight | | | | | | | |
| | | (Physical Property 1) | — | 1.80 | 1.80 | 1.80 | 1.78 | 1.80 | 1.80 |
| | | Mw/Mn | | | | | | | |
| | | (Physical Property 2) | — | 130 | 110 | 110 | 100 | 130 | 145 |
| | | Mooney Viscosity | | | | | | | |
| | | (Physical Property 3) | | 0.53 | 0.58 | 0.57 | 0.55 | 0.53 | 0.42 |
| | | Mooney Stress | | | | | | | |
| | | Relaxation Rate | | | | | | | |
| | | (Physical Property 4) | ppm | 108 | 110 | 110 | 98 | 108 | 108 |
| | | Silicon Content | | | | | | | |
| | | (Physical Property 5) | ppm | 76 | 78 | 78 | 62 | 76 | 76 |
| | | Nitrogen Content | | | | | | | |
| | | (Physical Property 6) | | 80 | 79 | 80 | 80 | 80 | 80 |
| | | Modification Ratio | | | | | | | |
| | | (Physical Property 7) | (mass | 10 | 22 | 10 | 10 | 10 | 10 |
| | | Amount | %) | | | | | | |
| | | of Bound Styrene | | | | | | | |
| | | (Physical Property 7) | (mol %) | 38 | 38 | 22 | 38 | 43 | 38 |
| | | Vinyl Bond Content | | | | | | | |
| | | (Physical Property 8) | (° C.) | −60 | −43 | −73 | −60 | −56 | −60 |
| | | Glass Transition | | | | | | | |
| | | Temperature | | | | | | | |
| | | (Physical Property 9) | | 0.73 | 0.87 | 0.79 | 0.75 | 0.75 | 0.66 |
| | | Phase Difference | | | | | | | |
| | | Index | | | | | | | |
| | | (Evaluation 1) Cold | | A | A | A | A | A | A |
| | | Flow Property | | | | | | | |
| | | | | | | | | Comp. | Comp. |
| | | | Ex. 7 | Ex. 8 | Ex. 9 | Ex. 10 | Ex. 11 | Ex. 1 | Ex. 2 |
| Modified Conjugated Diene-based Polymer | | | A7 | A8 | A9 | A10 | A11 | B1 | B2 |
| Poly- | Butadiene | | 22.3 | 17.3 | 22.3 | 22.3 | 22.3 | 22.3 | 16.1 |
| merization | Styrene | | 3.4 | 6.5 | 3.4 | 3.4 | 3.4 | 3.4 | 11.8 |
| Conditions | n-Hexane | | 100.4 | 100.4 | 100.4 | 100.4 | 100.4 | 100.4 | 100.4 |
| | n-Butyllithium for | | 0.104 | 0.104 | 0.104 | 0.104 | 0.104 | 0.104 | 0.104 |
| | Impurity Treatment | | | | | | | | |
| | n-Butyllithium of | | 0.234 | 0.234 | 0.224 | 0.224 | 0.224 | 0.302 | 0.239 |
| | Polymerization Initiator | | | | | | | | |
| | Polar Compound | | 0.094 | 0.094 | 0.094 | 0.094 | 0.094 | 0.094 | 0.127 |
| | Additional Butadiene | | 7.4 | 5.8 | 7.4 | 7.4 | 7.4 | 7.4 | 5.4 |
| | Branching | Used or not | a1 | a1 | a1 | a1 | a1 | — | a1 |
| | Agent | Amount Added | 0.012 | 0.012 | 0.012 | 0.012 | 0.012 | — | 0.012 |
| | Coupling | Type | b1 | b1 | b1 | b1 | b1 | — | b1 |
| | Modifier | Amount Added | 0.007 | 0.007 | 0.010 | 0.009 | 0.090 | — | 0.011 |
| | | Type | b2 | b2 | b2 | b2 | b2 | b2 | b2 |
| | | Amount Added | 0.117 | 0.117 | 0.087 | 0.082 | 0.080 | 0.150 | 0.105 |
| | Modified | (Physical Property 1) | 324,000 | 324,000 | 309,000 | 301,000 | 298,000 | 283,000 | 333,000 |
| | Conjugated | Number Average | | | | | | | |
| | Diene- | Molecular Weight | | | | | | | |
| | based | (Physical Property 1) | 576,000 | 576,000 | 600,000 | 614,000 | 611,000 | 510,000 | 600,000 |
| | Polymer | Weight Average | | | | | | | |
| | | Molecular Weight | | | | | | | |
| | | (Physical Property 1) | 1.78 | 1.78 | 1.94 | 2.04 | 2.05 | 1.80 | 1.81 |
| | | Mw/Mn | | | | | | | |
| | | (Physical Property 2) | 105 | 105 | 105 | 115 | 114 | 65 | 110 |
| | | Mooney Viscosity | | | | | | | |
| | | (Physical Property 3) | 0.66 | 0.66 | 0.65 | 0.55 | 0.60 | 0.80 | 0.57 |
| | | Mooney Stress | | | | | | | |
| | | Relaxation Rate | | | | | | | |
| | | (Physical Property 4) | 108 | 108 | 97 | 88 | 78 | 127 | 98 |
| | | Silicon Content | | | | | | | |
| | | (Physical Property 5) | 86 | 86 | 69 | 61 | 53 | 127 | 68 |
| | | Nitrogen Content | | | | | | | |
| | | (Physical Property 6) | 80 | 80 | 75 | 70 | 67 | 82 | 80 |
| | | Modification Ratio | | | | | | | |
| | | (Physical Property 7) | 10 | 22 | 10 | 10 | 10 | 10 | 35 |
| | | Amount | | | | | | | |
| | | of Bound Styrene | | | | | | | |
| | | (Physical Property 7) | 38 | 38 | 38 | 38 | 38 | 38 | 40 |
| | | Vinyl Bond Content | | | | | | | |
| | | (Physical Property 8) | −60 | −43 | −60 | −60 | −60 | −60 | −24 |
| | | Glass Transition | | | | | | | |
| | | Temperature | | | | | | | |
| | | (Physical Property 9) | 0.92 | 1.03 | 0.89 | 0.80 | 0.83 | 1.27 | 0.93 |
| | | Phase Difference | | | | | | | |
| | | Index | | | | | | | |
| | | (Evaluation 1) Cold | A | A | A | A | A | C | A |
| | | Flow Property | | | | | | | |
| | | | | | Comp. | Comp. | Comp. | Comp. | Comp. |
| | | | | | Ex. 3 | Ex. 4 | Ex. 5 | Ex. 6 | Ex. 7 |
| | | Modified Conjugated Diene-based Polymer | | | B3 | B4 | B5 | B6 | B7 |
| | | Poly- | Butadiene | | 22.3 | 22.3 | 22.3 | 22.3 | 22.3 |
| | | merization | Styrene | | 3.4 | 3.4 | 3.4 | 3.4 | 3.4 |
| | | Conditions | n-Hexane | | 100.4 | 100.4 | 100.4 | 100.4 | 100.4 |
| | | | n-Butyllithium for | | 0.104 | 0.104 | 0.104 | 0.104 | 0.104 |
| | | | Impurity Treatment | | | | | | |
| | | | n-Butyllithium of | | 0.234 | 0.265 | 0.271 | 0.239 | 0.219 |
| | | | Polymerization Initiator | | | | | | |
| | | | Polar Compound | | 0.094 | 0.062 | 0.094 | 0.062 | 0.094 |
| | | | Additional Butadiene | | 7.4 | 7.4 | 7.4 | 7.4 | 7.4 |
| | | | Branching | Used or not | — | a1 | — | a1 | a1 |
| | | | Agent | Amount Added | — | 0.014 | — | 0.012 | 0.012 |
| | | | Coupling | Type | b3 | b1 | — | b1 | b1 |
| | | | Modifier | Amount Added | 0.075 | 0.012 | — | 0.018 | 0.008 |
| | | | | Type | — | b2 | b2 | b2 | b2 |
| | | | | Amount Added | — | 0.116 | 0.140 | 0.075 | 0.077 |
| | | | Modified | (Physical Property 1) | 350,000 | 316,000 | 305,000 | 375,000 | 296,000 |
| | | | Conjugated | Number Average | | | | | |
| | | | Diene- | Molecular Weight | | | | | |
| | | | based | (Physical Property 1) | 610,000 | 560,000 | 549,000 | 685,000 | 626,000 |
| | | | Polymer | Weight Average | | | | | |
| | | | | Molecular Weight | | | | | |
| | | | | (Physical Property 1) | 1.74 | 1.77 | 1.80 | 1.82 | 2.08 |
| | | | | Mw/Mn | | | | | |
| | | | | (Physical Property 2) | 115 | 90 | 88 | 118 | 115 |
| | | | | Mooney Viscosity | | | | | |
| | | | | (Physical Property 3) | 0.63 | 0.62 | 0.72 | 0.45 | 0.62 |
| | | | | Mooney Stress | | | | | |
| | | | | Relaxation Rate | | | | | |
| | | | | (Physical Property 4) | 108 | 111 | 115 | 98 | 73 |
| | | | | Silicon Content | | | | | |
| | | | | (Physical Property 5) | 0 | 86 | 115 | 62 | 49 |
| | | | | Nitrogen Content | | | | | |
| | | | | (Physical Property 6) | — | 80 | 80 | 80 | 65 |
| | | | | Modification Ratio | | | | | |
| | | | | (Physical Property 7) | 10 | 10 | 10 | 10 | 10 |
| | | | | Amount | | | | | |
| | | | | of Bound Styrene | | | | | |
| | | | | (Physical Property 7) | 38 | 22 | 38 | 22 | 38 |
| | | | | Vinyl Bond Content | | | | | |
| | | | | (Physical Property 8) | −60 | −73 | −60 | −73 | −60 |
| | | | | Glass Transition | | | | | |
| | | | | Temperature | | | | | |
| | | | | (Physical Property 9) | 0.90 | 0.88 | 1.08 | 0.63 | 0.85 |
| | | | | Phase Difference | | | | | |
| | | | | Index | | | | | |
| | | | | (Evaluation 1) Cold | A | B | B | A | A |
| | | | | Flow Property | | | | | |

(Evaluation of Rubber Compositions)

The modified conjugated diene-based polymers A1 to A11 and B1 to B7 shown in Table 1 were respectively used as raw materials to obtain rubber compositions in accordance with the following composition:

Modified conjugated diene-based polymer (any one of A1 to A11 and B1 to B7): 70 parts by mass (excluding oil)

Butadiene rubber (trade name “BR150”, manufactured by Ube Industries, Ltd.): 30 parts by mass

Silica (trade name “Ultrasil 7000GR”, manufactured by Evonik Degussa, nitrogen adsorption specific surface area: 170 m²/g): 75.0 parts by mass

Carbon black (trade name “Seast KH (N339)”, manufactured by Tokai Carbon Co., Ltd.): 5.0 parts by mass

Silane coupling agent: (trade name “Si75”, manufactured by Evonik Degussa, bis(triethoxysilylpropyl)disulfide): 6.0 parts by mass

S-RAE oil (trade name “Process NC140”, manufactured by JX Nippon Oil & Energy Corporation): 32.0 parts by mass

Zinc oxide: 2.5 parts by mass

Stearic acid: 2.0 parts by mass

Anti-aging agent (N-(1,3-dimethylbutyl)-N′-phenyl-p-phenylenediamine): 2.0 parts by mass

Sulfur: 1.7 parts by mass

Vulcanization accelerator 1 (N-cyclohexyl-2-benzothiazylsulfinamide): 1.7 parts by mass

Vulcanization accelerator 2 (diphenylguanidine): 2.0 parts by mass

Specifically, the above-described materials were kneaded by the following method to obtain a rubber composition. A closed kneader (having an internal volume of 0.5 L) equipped with a temperature controller was used to knead, as a first stage of kneading, the modified conjugated diene-based polymer (any one of A1 to A11 and B1 to B7), the butadiene rubber, the fillers (silica and carbon black), the silane coupling agent, the S-RAE oil, zinc oxide and stearic acid under conditions of a filling ratio of 65% and a rotor rotation speed of 30 to 50 rpm. Here, the temperature of the closed kneader was controlled to obtain each rubber composition (compound) at a discharging temperature of 155 to 160° C.

Next, after cooling the compound obtained as described above to room temperature, as a second stage of the kneading, the anti-aging agent was added thereto, and the resultant was kneaded again under the same conditions as those for the first stage of the kneading to improve dispersibility of the silica. Also in this case, the discharging temperature for the compound was adjusted to 155 to 160° C. by the temperature control of the kneader. After cooling, as a third stage of the kneading, sulfur and the vulcanization accelerators 1 and 2 were added thereto, and the resultant was kneaded by an open roll set to 70° C. Thereafter, the resultant was molded and vulcanized at 160° C. for 20 minutes by a vulcanizing press. The rubber compositions before the vulcanization, and the rubber compositions after the vulcanization were evaluated. Specifically, the evaluations were performed as described below. Results are shown in Table 2.

(Evaluation 1) Cold Flow Property

Each of the modified conjugated diene-based polymers before vulcanization produced by the methods described in Examples and Comparative Examples was cut into 3 cm×3 cm×8 cm in thickness, and the 3 cm×3 cm surface was fixed to a table inclined by 30°. For a cold flow property, the appearance of the sample was observed at 25° C. 1 hour later. Results were evaluated according to the criteria given below. A sample that retained the original state was evaluated as a low cold flow property and excellent form retainability.

A (Excellent): A sample retained almost the original state.

B (Good): A sample was partially deformed.

C (Poor): A sample was heavily deformed.

(Evaluation 2) Viscoelastisity Parameter (Fuel Economy/Wet Grip Performance)

A viscoelasticity testing machine “ARES” manufactured by Rheometric Scientific, Inc. was used to measure a viscoelasticity parameter in a torsion mode. Each measurement value was shown as an index obtained assuming that a result obtained in the rubber composition of Comparative Example 1 was 100. Here, a tan δ measured at 50° C. at a frequency of 10 Hz and strain of 3% was used as an index of a low hysteresis loss property, namely, fuel efficiency, and shown as an index obtained assuming that a result of Comparative Example 1 was 100. A larger index indicates better fuel efficiency, and one having such a value over 65 was evaluated as excellent fuel efficiency. Besides, a tan δ measured at 0° C. at a frequency of 10 Hz and strain of 1% was used as an index of wet grip performance, and shown as an index obtained assuming that a result of Comparative Example 1 was 100. A larger index indicates better wet grip performance, and one having such a value over 65 was evaluated as excellent wet grip performance.

(Evaluation 3) Tensile Strength and Tensile Elongation

Tensile strength and tensile elongation were measured in accordance with a tensile test method according to JIS K6251. Each measured value was shown as an index obtained assuming that a result of Example 9 was 100. A larger value indicates better tensile strength and tensile elongation and attains excellent fracture performance.

(Evaluation 4) Abrasion Resistance

An Acron abrasion tester (manufactured by Yasuda Seiki Seisakusho, Ltd.) was used to measure an abrasion amount through 1,000 rotations at a load of 44.4 N in accordance with JIS K6264-2. Each measured value was shown as an index obtained assuming that a result of Comparative Example 1 was 100. A larger index indicates better abrasion resistance, and one having such a value over 80 was evaluated as excellent in abrasion resistance.

(Evaluation 5) Average Value

An average value of indexes of fuel efficiency, wet grip performance, tensile strength, tensile elongation, and abrasion resistance was described. A larger value means better balance among these performances, and one over 100 was regarded as being excellent.

TABLE 2

| | | Ex. | Ex. | Ex. | Ex. | Ex. | Ex. | Ex. | Ex. | Ex. |
|---|---|---|---|---|---|---|---|---|---|---|
| | | 1 | 2 | 3 | 4 | 4 | 6 | 7 | 8 | 9 |
| Modified Conjugated Diene-based Polymer | | A1 | A2 | A3 | A4 | A5 | A6 | A7 | A8 | A9 |
| Physical | (Evaluation 2) Viscoelasticity | 80 | 85 | 82 | 80 | 78 | 77 | 82 | 87 | 77 |
| Property | Parameter (Fuel Efficiency) | | | | | | | | | |
| Value | (Evaluation 2) Viscoelasticity | 100 | 127 | 82 | 100 | 103 | 101 | 100 | 127 | 100 |
| | Parameter (Wet Grip Performance) | | | | | | | | | |
| | (Evaluation 3) Tensile Strength | 120 | 120 | 110 | 120 | 120 | 120 | 120 | 120 | 110 |
| | (Evaluation 3) Tensile Elongation | 120 | 115 | 115 | 115 | 120 | 117 | 123 | 125 | 122 |
| | (Evaluation 4) Abrasion resistance | 120 | 90 | 140 | 110 | 116 | 125 | 110 | 85 | 115 |
| | Average | 108 | 107 | 106 | 105 | 107 | 108 | 107 | 109 | 105 |
| | | Ex. | Ex. | Comp. | Comp. | Comp. | Comp. | Comp. | Comp. | Comp. |
| | | 10 | 11 | Ex. 1 | Ex. 2 | Ex. 3 | Ex. 4 | Ex. 5 | Ex. 6 | Ex. 7 |
| Modified Conjugated Diene-based Polymer | | A10 | A11 | B1 | B2 | B3 | B4 | B5 | B6 | B7 |
| Physical | (Evaluation 2) Viscoelasticity | 73 | 68 | 100 | 60 | 40 | 88 | 90 | 77 | 64 |
| Property | Parameter (Fuel Efficiency) | | | | | | | | | |
| Value | (Evaluation 2) Viscoelasticity | 100 | 100 | 100 | 560 | 100 | 82 | 100 | 82 | 100 |
| | Parameter (Wet Grip Performance) | | | | | | | | | |
| | (Evaluation 3) Tensile Strength | 110 | 110 | 100 | 130 | 115 | 100 | 110 | 104 | 110 |
| | (Evaluation 3) Tensile Elongation | 117 | 117 | 100 | 105 | 105 | 110 | 110 | 105 | 115 |
| | (Evaluation 4) Abrasion resistance | 113 | 112 | 100 | 70 | 110 | 135 | 105 | 135 | 110 |
| | Average | 103 | 101 | 100 | 185 | 94 | 103 | 103 | 100 | 100 |

As is evident from Tables 1 and 2, the modified conjugated diene-based polymer of the present invention is excellent in form retainability, and excellent in performance balance among abrasion resistance, fracture performance, and a low hysteresis loss property of a vulcanizate obtained therefrom.

A modified conjugated diene-based polymer, a method for producing a modified conjugated diene-based polymer, a modified conjugated diene-based polymer composition, and a rubber composition, etc. of the present invention are excellent in form retainability of the modified conjugated diene-based polymer, and excellent in performance balance among abrasion resistance, fracture performance, and a low hysteresis loss property of a vulcanizate obtained therefrom, and therefore, are available widely and effectively in applications such as a tire, resin modification, interior and exterior of a vehicle, an anti-vibration rubber, and shoes.

1. A modified conjugated diene-based polymer, comprising a nitrogen atom and a silicon atom, wherein
a Mooney viscosity measured at 100° C. is 100 or more and 150 or less, a Mooney stress relaxation rate measured at 100° C. is 0.40 or more and 0.70 or less, a glass transition temperature Tg is −90° C. to −40° C., and a phase difference index measured at 160° C. and 0.1 Hz is 0.65 or more and 1.10 or less, and
each of a nitrogen content and a silicon content is 50 ppm or more based on a mass with respect to the total amount of the modified conjugated diene-based polymer.

2. The modified conjugated diene-based polymer according to claim 1, wherein
the modified conjugated diene-based polymer has a molecular weight distribution (Mw/Mn) of 1.5 or more and less than 2.5.

3. The modified conjugated diene-based polymer according to claim 1, wherein
the Mooney viscosity measured at 100° C. is 100 or more and 130 or less.

4. The modified conjugated diene-based polymer according to claim 1, wherein
the Mooney stress relaxation rate measured at 100° C. is 0.50 or more and 0.70 or less.

5. The modified conjugated diene-based polymer according to claim 1, wherein
a vinyl bond content in the conjugated diene-based polymer is 15 to 43%.

6. A method for producing the modified conjugated diene-based polymer according to claim 1, comprising:
a step of obtaining a modified conjugated diene-based polymer by polymerizing at least a conjugated diene compound and an aromatic vinyl compound with an organic lithium compound used as a polymerization initiator, and with a coupling modifier reacted.

7. A modified conjugated diene-based polymer composition, comprising
100 parts by mass of the modified conjugated diene-based polymer according to claim 1, and
1.0 part by mass or more and 60 parts by mass or less of a rubber softener.

8. A rubber composition, comprising
a rubber component comprising 50 parts by mass or more of the modified conjugated diene-based polymer according to claim 1, and
5.0 parts by mass or more and 150 parts by mass or less of a filler with respect to 100 parts by mass of the rubber component.
